(19) United States
(12) Patent Application Publication
(10) Pub. No.: US 2024/0395036 A1
(43) Pub. Date: Nov. 28, 2024

(54) VIDEO DATA ACQUISITION USING ARTIFICIAL INTELLIGENCE FOR QUARTERBACK SELECTION BY THE NATIONAL FOOTBALL LEAGUE

(71) Applicants: R. Kemp Massengill, Palos Verdes, CA (US); David E. Newman, Poway, CA (US)

(72) Inventors: R. Kemp Massengill, Palos Verdes, CA (US); David E. Newman, Poway, CA (US)

(21) Appl. No.: 18/503,048

(22) Filed: Nov. 6, 2023

Related U.S. Application Data
(60) Provisional application No. 63/468,626, filed on May 24, 2023.
(60) Provisional application No. 63/468,891, filed on May 25, 2023.
(60) Provisional application No. 63/512,729, filed on Jul. 10, 2023.
(60) Provisional application No. 63/512,984, filed on Jul. 11, 2023.
(60) Provisional application No. 63/527,665, filed on Jul. 19, 2023.
(60) Provisional application No. 63/529,991, filed on Jul. 31, 2023.
(60) Provisional application No. 63/586,857, filed on Sep. 29, 2023.
(60) Provisional application No. 63/594,281, filed on Oct. 30, 2023.

(51) Int. Cl. G06V 20/40; G06V 10/82; G06V 40/20

(52) U.S. Cl. CPC G06V 20/42; G06V 10/82; G06V 40/25

(57) ABSTRACT

The college quarterback who displays outstanding talent of sufficient interest to National Football League teams can be effectively analyzed in intense granular detail using the present disclosure's video freeze-frame/AI-cross-correlation technology—and other Artificial Intelligence modalities. Very few cross-correlations can be intellectually accommodated at one time by humans—even by the very smartest and most talented human beings on the planet. The infinitely-possible simultaneous AI analyses, correlations, and cross-correlations of the gigantic number of physical, mental, and emotional attributes enables selection of a potential NFL quarterback (and that of other positions) with superior accuracy and much less guesswork than the current system fraught with uncertainly. Throwing a ‘catchable’ pass is essential—as is completing passes in the face of a ferocious defensive pass rush—or making alternative correct split-second decisions, such as ‘scrambling’ for a first-down when necessary. These are paramount requirements for a winning NFL quarterback. The National Football League quarterback must overcome ALL adversity and WIN—especially when the game is on the line. Having the winning quarterback is mandatory for NFL coaches and team owners paying the bills in their supreme quest for victory in the SUPER BOWL. Losing is NOT an option in the National Football League.

### PRIORITY CLAIMS AND RELATED APPLICATIONS

This application claims the benefit of U.S. Provisional Patent Application Ser. No. 63/468,626, entitled “ARTIFICIAL INTELLIGENCE FOR ATHLETIC METRICS”, filed May 24, 2023, and U.S. Provisional Patent Application Ser. No. 63/468,891, entitled “ARTIFICIAL INTELLIGENCE FOR NATIONAL FOOTBALL LEAGUE ATHLETIC METRICS”, filed May 25, 2023, and U.S. Provisional Patent Application Ser. No. 63/512,729, entitled “ARTIFICIAL INTELLIGENCE FOR NATIONAL FOOTBALL LEAGUE ATHLETIC METRICS”, filed Jul. 10, 2023, and U.S. Provisional Patent Application Ser. No. 63/512,984, entitled “ARTIFICIAL INTELLIGENCE FOR NATIONAL FOOTBALL LEAGUE ATHLETIC METRICS”, filed Jul. 11, 2023, and U.S. Provisional Patent Application Ser. No. 63/527,665, entitled “ARTIFICIAL INTELLIGENCE METRICS FOR QUARTERBACK POSITION IN THE NATIONAL FOOTBALL LEAGUE”, filed Jul. 19, 2023, and U.S. Provisional Patent Application Ser. No. 63/529,991, entitled “METRICS CROSS-CORRELATIONS EMPLOYING AI FOR NATIONAL FOOTBALL LEAGUE QUARTERBACKS”, filed Jul. 31, 2023, and U.S. Provisional Patent Application Ser. No. 63/586,857, entitled “VIDEO DATA ACQUISITION USING ARTIFICIAL INTELLIGENCE FOR QUARTERBACK SELECTION BY THE NATIONAL FOOTBALL LEAGUE”, filed Sep. 29, 2023, and U.S. Provisional Patent Application Ser. No. 63/594,281, entitled “VIDEO DATA ACQUISITION USING ARTIFICIAL INTELLIGENCE FOR QUARTERBACK SELECTION BY THE NATIONAL FOOTBALL LEAGUE”, filed Oct. 30, 2023, all of which are hereby incorporated by reference in their entireties. This application is also related to U.S. patent application Ser. No. 18/356,882, entitled “ARTIFICIAL INTELLIGENCE METRICS FOR QUARTERBACK POSITION IN THE NATIONAL FOOTBALL LEAGUE”, filed Jul. 21, 2023, the contents of which are incorporated herein by reference in their entireties.

### FIELD OF THE INVENTION

The disclosure pertains to AI-based predictions of athletic performance, and more particularly to the prediction of National Football League (NFL) player performance at the quarterback position, using AI (Artificial Intelligence) models and algorithms derived from AI models.

### BACKGROUND OF THE INVENTION

Athletic analysis of potential ability at the quarterback position is currently wrought with many subjective and often-wrong decisions, thus explaining why first-round National Football League (“NFL”) quarterback draft picks with amazing college credentials often ‘flame out’ and are ‘busts’ in the professional arena of the NFL. The list of these unfortunate ‘busts’ at quarterback—by far the most important position of all positions in football, and akin to a Field Marshall in the military—is a very long one, to the huge chagrin of NFL owners, who generally ‘guarantee’ many millions of dollars to these high draft choice quarterback ‘flame-outs.’

Consider this: The NFL pro football quarterback renowned as the Greatest Of All Time (‘G.O.A.T’) was a lowly 6th round draft pick as the number 199 player taken in the 2000 National Football League draft. This is Tom Brady, who quarterbacked NFL teams to an almost unbelievably astounding seven Super Bowl victories—winning in five of these Super Bowls the Most Valuable Player Award. [The Super Bowl is the culmination of the season for the now 32 NFL teams, where the best two teams play for the Championship. It is huge sporting event, watched by over 100 million rabid fans—and the prestige of winning is enormous.]

It should be noted that quarterback players drafted in the 6th round, as was Tom Brady, are generally suitable only for the ‘practice squad’ and are, essentially, ‘cannon fodder’ in the jargon of professional football.

And it is a fact that six quarterbacks were drafted before Tom Brady in the 2000 NFL draft. What happened to these quarterbacks?

The six quarterbacks drafted by the NFL before Brady were to ‘start’[meaning, to begin the game at the quarterback position] 191 games and throw 258 touchdowns. Brady WON 286 games in his career, including seven Super Bowls, and threw 737 touchdowns. None of the six quarterbacks is remembered very much today, except by hard-core professional football fans.

It would be instructive to review the histories of these other six quarterbacks drafted ahead of Tom Brady. So doing dramatically illustrates the exasperatingly enigmatic and truly thorny problem of drafting a quarterback who actually performs at the originally-forecasted winning level when ultimately faced with the relentless rigor of the professional National Football League.

Thus, in more detail, here are how Tom Brady's fellow class of 2000 drafted quarterbacks actually fared once in National Football League:
Chad Pennington (Round 1, Pick 18, New York Jets): Sadly, Pennington was injured and was unable to fulfill a notable career in the NFL. [Injuries play havoc with NFL football careers at all positions, and quarterback is no exception. The NFL has often been compared to the gladiator games 1,800 years ago in the Roman Colosseum.]
Giovanni Carmazzi (Round 3, Pick 63, San Francisco 49ers): Unfortunately for Carmazzi, his NFL journey lasted just one year, during which time he never made a single regular season appearance.
Chris Redman (Round 3, Pick 75, Baltimore Ravens): An extremely successful high school career culminated when he listed by Parade Magazine as its 1994 National Player of the Year. He also set a national high school football record for 57 touchdown passes in a season. In college, as a University of Louisville starting quarterback, Redman received the Johnny Unitas Golden Arm Award for his quarterback prowess. He was also named the Conference USA Offensive Player of the Year. In 2003, Redman underwent back surgery and in the same year, he suffered a torn labrum in his right shoulder. This significantly affected his on-the-field performance, although very much to his credit and his mental toughness, he soldiered on in the National Football League with the New England Patriots and subsequently with the Tennessee Titans.
Tee Martin (Round 5, Pick 163, Pittsburgh Steelers): Tee Martin was a sensational college quarterback for the University of Tennessee, leading the 1998 team to an undefeated 13-0 season, and victory in the college National Championship. Martin's. 880 winning percentage remains to this day the best in Tennessee school history. Drafted by the Pittsburgh Steelers, Martin played only three years in the NFL. Although not destined for NFL glory as a quarterback, the great news is that Tee Martin has exceptional coaching skills. For instance, at the University of Southern California (USC), Martin coached eleven NFL Draft picks, including nine players selected in the first three rounds. He is currently the quarterbacks coach for the NFL's Baltimore Ravens.
Marc Bulger (Round 6, pick 168, New Orleans Saints): Cut by the New Orleans Saints in the preseason, and then with a brief stint with the Atlanta Falcons, Mark Bulger went on to have a respectable career with the St. Louis Rams. Interestingly, Marc Bulger's performance was superior to that of the four quarterbacks drafted ahead of him-demonstrating once again how uncommonly difficult it is for human beings to pick quarterbacks who become winners in the National Football League!
Spergon Wynn (Round 6, pick 183. Cleveland Browns): 0-3 career record. 585 passing yards, 1 touchdown, 7 interceptions. Ultimately, Spergon Wynn did not do well enough to garner more than one start with the Browns.

The point, then, of this detailed summary is to show that picking a winning National Football League quarterback is essentially like a dice throw, or akin to betting on roulette in Las Vegas. It is a fact that no one—even the best talent scouts and the most successful coaches—really knows the outcome of drafting a professional National Football League quarterback. There is currently no crystal ball predicting the future here!

For further elucidation of the huge difficulty to judge how enigmatic it truly is to determine how well a quarterback will ultimately perform in the NFL, let's return to the example of the amazing Tom Brady—the ‘Greatest Of All Time’ (G.O.A.T).

To reiterate: The six quarterbacks picked in the draft before Tom Brady were never Super Bowl winners as was Tom Brady, much less Most Valuable Players in the Super Bowl, as was Tom Brady, none is in Professional Football Hall of Fame, as is Tom Brady, and in essence, although doing their best, were generally not suitably accomplished in the National Football League, in spite of stellar performances at the lower level of college football.

How is it possible that all the pundits and gurus in the world of professional football were very far off the mark with reference to Tom Brady?

And these pundits and gurus are never a group of slouches or lazy ne'er-do-wells. They are one and all very smart, indeed! The problem is therefore in the uniquely peculiar nature of the National Football League quarterback position. It should be emphasized that the inability to judge ultimate greatness, or lack thereof—especially with the position of quarterback—is certainly not one of incompetence on the part of talent scouts and coaches. These are without exception highly intelligent, extremely dedicated, and very experienced football sports Professionals.

Winston Churchill's famous quote regarding cold-war Russia most certainly applies to the position of professional NFL football quarterback: “It is a riddle wrapped in a mystery inside an enigma.”

That stated, it is worthwhile herein to delve into the early background of Tom Brady's phenomenal career in more detail.

As per above, Tom Brady was selected in the 2000 NFL draft in the 6^{th} round as the 199th overall pick—and the seventh quarterback to be chosen. Obviously, his fantastic potential was initially invisible, as Brady failed to impress not even a single team at the NFL Scouting Combine.

Also known simply as the ‘Combine,’ this four-day event allows talent scouts and coaches from all NFL teams [at Brady's time—31 teams] to evaluate that year's draft-eligible college players on a variety of medical, mental, and physical criteria.

Here are some of the comments NFL scouting personnel had to say of Brady's mediocre ho-hum Combine performance, all this, of course, before Brady's Hall of Fame/Greatest Of All Time (‘G.O.A.T.’) professional football career:

One scout noted Brady was “Awful. He's not even on my board. Weak. He will make somebody a good husband or a good medical salesman.” Another expert quarterback scout said, “Backup. Yes. Could be a backup in this league. He has the size but not enough arm.”

Years later, Tom Brady told CBS News: “Twenty-two years ago every single National Football League team [31 NFL teams in year 2000] skipped over me five times-after they had me do a local [Combine] workout and decided I wasn't good enough to play there.”

Needless to say, in retrospect, the professional NFL scouting experts were dismally wrong about Tom Brady. Brady went on to win seven Super Bowls, and no one has come anywhere close to matching this monumental achievement. And it was not the fault of the professional NFL scouting experts that Brady was such a lowly draft choice. Rather, the fault lies with the nigh-unto-impossible task of evaluating a quarterback not yet in the National Football League as to his ultimate performance in the NFL.

How can it be that the super-human Tom Brady (maybe even from a different planet, if one believes in space travel?) was drafted so very low—6^{th} round/pick number 199 in the NFL 2000 draft? And this by very smart football experts who study the game in huge detail—and usually bleary-eyes well into the night, and almost always for over one hundred hours a week. How do you explain this Tom Brady phenomenon? The answer: You can't! It defies human explanation!

Yes, Tom Brady cemented himself as the greatest player AT ANY POSITION ever to play National Football League football—truly—the Greatest Of All Time (‘G.O.A.T.’). And this is comparing Brady's achievements not only to quarterbacks but to every single athlete to ever play NFL football—and that is close to 25,000 NFL athletes since the inception of the National Football League 123 years ago in 1920. And of the 371 players enshrined in the NFL Hall of Fame, Tom Brady is the Number One of them all.

Thus, what does it take to be a winning quarterback in the national football league? According to Bill Walsh—San Francisco 49ers' Head Coach and NFL Hall of Fame member—widely considered to be one of the greatest coaches in National Football League history, and a lauded ‘genius’ at offensive football strategies (including inventor of the ‘West Coast Offense’), this is what it takes:

“To become a great quarterback, there must be instincts and intuition. This is the area that can be the difference between a very solid quarterback and a great quarterback. This isn't an area you can do much with as a coach. You can certainly bring a quarterback up to a competitive standard, but to reach greatness, the quarterback must possess that inherently, ala Billy Kilmer, Sonny Jurgensen, Ken Stabler and Warren Moon.

“If throwing a ball were the only aspect of playing quarterback, then this would be an easy position to evaluate. However, because of the dynamic role he plays on the team, a quarterback must have physical, mental, emotional, and instinctive traits that go well beyond the mere ability to pass a football.

“Still, if he can't pass, he obviously won't be a good quarterback either. For now, let's assume our quarterback candidate has shown an ability to throw the ball.

“He must be courageous and intensely competitive. He will be the one on the field who is running the team. His teammates must believe in him—or it may not matter how much physical ability he has. If he is courageous and intensely competitive, then other players will know and respect that. This will be a foundation for becoming a leader.

“Naturally, he will have to perform up to certain physical standards to maintain that respect and become a leader.

“Arm strength is somewhat misleading. Some players can throw 80 yards, but they aren't good passers. Good passing has to do with accuracy, timing, and throwing a ball with touch so it is catchable. This all involves understanding a system, the receivers in the system, and having great anticipation. It is a plus to be able to throw a ball on a line for 35 yards, but not if it is off target or arrives in such a way that it is difficult to catch. Remember, the goal of passing a ball is to make sure it is caught by your intended receiver.

“You look at how complete an inventory of throws a quarterback possesses—from screen passes to timed short passes to medium range passes and down-the-field throws. But you are looking to evaluate a quarterback in all facets and distances and types of passes in throwing the ball.

“There have been quarterbacks of greatness, Hall of Fame quarterbacks, who didn't have a complete inventory of passes. But you're looking to see the potential of the quarterback in each area. You can see where the emphasis of the offense would be if he were with your team.

“A quick delivery, one that is not telegraphed to help the defense, gives the quarterback an advantage when he finds his intended target. That's when it is essential to get the ball ‘up and gone’ with no wasted motion. Some of this can be acquired by learning proper technique. But to a certain degree, a quick release is related to a quarterback's reaction time between spotting his receiver and getting the ball ‘up and gone.’

“Touch is important, especially in a medium range passing game. One of Joe Montana's most remarkable skills was putting the right touch on a pass so that it was easily catchable by a receiver, who often did not have to break stride.

“The ability to read defenses is not something that players have learned to a high degree coming out of college. Even if they have, the pro defenses are very different. But most systems require quarterbacks to look at primary and secondary receivers, usually based on the defense that confronts him. You can see if he locates that secondary receiver—or maybe even an emergency outlet receiver—with ease or with a sense of urgency.

“This should work like a natural progression, not a situation where it's—‘Oh, my gosh, now I must look over here . . . no, over there.’ You can see which quarterbacks handle these situations with grace. These are the types who have a chance to perform with consistency in the National Football League.

“Mobility and an ability to avoid a pass rush are crucial. Some quarterbacks use this mobility within the pocket [the area immediately behind the center who ‘snaps’ the ball to the quarterback] just enough so they are able to move and pass when they ‘feel’ a defensive rush. But overall quickness and agility can make a remarkable difference. As an example, there were some very quick boxers in Sugar Ray Leonard's era, but he was quicker than they were and because of that he became a great champ.

“Quarterbacks must be able to function while injured. The pro season is about twice as long and more punishing than a college season. They are vulnerable to getting hit hard every time they pass. They must be able to avoid being rattled, get up and show they are in control and can continue to lead the offense.”

Continuing to quote Coach Walsh: “The single trait that separates great quarterbacks from good quarterbacks is the ability to make the great, spontaneous decision—especially at a crucial time. The clock is running down and your team is five points behind. The play that was called has broken down and 22 players are moving in almost unpredictable directions all over the field.

“This is where the great quarterback uses his experience, vision, mobility and what we will call spontaneous genius. He makes something good happen.”

And this is Super Bowl winning Head Coach Pete Carroll of the Seattle Seahawks on Bill Walsh's quarterback philosophy of the supreme importance of the quarterback position:

“Coach Walsh was one of the great quarterback gurus in the history of the game, and he convinced me that everything a coach does in designing his offense should be about making it easy for his quarterback, because his job is so difficult. [Coach Walsh] believed that everything should be structured with the quarterback in mind.”

Back to our spot-lighted quarterback subject, Tom Brady, with seven Super Bowl wins to his credit: To accentuate how super-human Tom Brady became in his National Football League career, and certainly to the amazement of everyone—and especially to the coaches and scouts who evaluated him as an NFL pro football quarterback prospect and drafted him as the lowly 199 pick—here is another remarkable fact:

Brady finally retired at the truly ancient age [for professional football] of 45—when many of his teammates were in their 20s, generally to retire from the NFL before they were 30. Tom Brady was old enough to be the father of many of his wide receivers, for instance.

Now, for further elucidation of the confounding enigma of drafting an NFL quarterback who actually can win when ‘the chips are down,’ let's examine the history of several other National Football League quarterbacks.

For completeness, the next highest NFL Super Bowl winners after the seven Super Bowls quarterbacked by Tom Brady, are Terry Bradshaw and Joe Montana—with four Super Bowl victories apiece.

Terry Bradshaw was selected out of Louisiana Tech University as the Number 1 pick in the first round of the 1970 NFL draft (they got it right on this one); and Joe Montana from Notre Dame was selected at the very bottom of the 3rd round in the 1979 NFL draft as pick number 82. Both Terry Bradshaw and Joe Montana are enshrined in the NFL Pro Football Hall of Fame—as will, of course, be Tom Brady.

So, how can you explain the dramatically indefinable differences between the NFL quarterback draft selections of Terry Bradshaw (Number 1), Joe Montana (Number 82), and Tom Brady (Number 199)—and the six quarterbacks drafted by the NFL ahead of Tom Brady? Again, you cannot!

With the current art employing human beings to make quarterback evaluation decisions, these huge discrepancies simply cannot be explained away. Quarterback talent evaluations in the National Football League often fail, and sometimes fail miserably.

Here is yet another example where the NFL talent-appraising experts fell short of the mark in their analyses of two top-tier college quarterback prospects: Peyton Manning and Ryan Leaf. The vast differences in ultimate performance of these top two National Football League first-round draft choices is baffling beyond explanation.

The facts are that Peyton Manning was drafted in the 1998 NFL draft as the first-round Number 1 pick, and Ryan Leaf was drafted in this same draft as the NFL first-round Number 2 pick. Before a single down of NFL football, the consensus was that both quarterbacks were essentially of the same ultra-premium caliber. But what happened?

Peyton Manning won two NFL Super Bowls and has been elected to the NFL Pro Football Hall of Fame. Ryan Leaf was unsuccessful in the NFL, and after several personal setbacks, became a football analyst and motivational speaker. Why the difference? It is a conundrum for certain.

No discussion of the enigmatic difficulty in drafting a winning quarterback into the NFL would be complete without reviewing the current phenomenal success of Brock Purdy, previously known before his NFL debut as ‘Mr. Irrelevant.’ This is the title presented to the very last selection in each year's NFL draft, and is a parody, a laughable spoof at the expense of the drafted athlete. Dating back to 1976, ‘Mr. Irrelevant’ and his family are invited for a week of festivities in Newport Beach, California, where they are feted with a trip to Disneyland, a golf tournament, a regatta, a roast giving advice to the new draftee, and a ceremony awarding ‘Mr. Irrelevant’ the ‘Lowsman Trophy.’ This trophy mimics—but is the exact opposite—of the Heisman Trophy presented to each year's best college football player who displays the most incredible athletic ability on the football field at any position. In stark contrast, the Lowsman Trophy depicts a player fumbling a football—OOPS! The whole Lowsman concept is ridiculous, of course, because ‘Mr. Irrelevant’ as a National Football League athlete is just that—almost without exception—‘irrelevant.’

Note: Because of Purdy's totally unexpected and off-the-charts quarterback success, Garoppolo and Lance were traded in 2023 for future high draft choices, as well as to limit the financial hit on the San Francisco 49ers' salary cap—$27M/year was designated for Garoppolo, for instance.

Inserted onto the playing field with no real aspirations of success—rather a stop-gap measure while the proven starting quarterbacks heal from injury—Purdy, to the total amazement of every single person in the professional football world, as of Oct. 1, 2023, has won 9 straight games as the San Francisco 49ers' starting quarterback. And this winning streak can continue when the 49ers play the Dallas Cowboys on Oct. 8, 2023. Of special note is that Brock Purdy is only the 4^{th} quarterback in the NFL's 123-year history to start his career 9-0 or better, and this is taking into account the many quarterbacks who were first-round draft picks, or even the Number One selection in that year's entire draft.

NBC Sports Headline Oct. 1, 2023: “Brock touches on near-perfect game after 49ers' win over Cardinals.” Brock Purdy broke the San Francisco 49ers' all-time single-game completion percentage record on Oct. 1, 2023, with his fantastic performance against the Arizona Cardinals—20 completions out of 21 passes. Purdy's 95.2% completion rate in this 49ers-Cardinals game tops the very best game ever of San Francisco 49ers' quarterback Steve Young [now in the NFL Hall of Fame]. In so doing, Purdy surpassed the 90% completion rate in Young's 18/20 quarterback performance back in 1991, i.e., 32 years ago. And the San Francisco 49ers professional football team dates all the way back to 1946, i.e., 77 years ago.

Brock Purdy's quarterback rating in this Oct. 1, 2023 San Francisco 49ers-Arizona Cardinals game—a stratospheric 134.6. And Purdy's 2022 season quarterback rating of 107.3 surpasses that of Super Bowl winner/SB Most Valuable Player (MVP) Patrick Mahomes' 2022 season rating with the Kansas City Chiefs of 105.2. Brock Purdy's 2022 quarterback rating is the highest ever for a rookie with at least 200 passes.

And this remarkable fact: Purdy's performance against the Arizona Cardinals yielded the best single-game rating and completion percentage (95.2 percent) of any National Football League quarterback in any game during the last four seasons. And that's over 500 games!

Flash update 1: The anxiously awaited Oct. 8, 2023 game between the San Francisco 49ers and the Dallas Cowboys [one of co-inventor RKM's favorite teams] resulted in a blow-out win by the 49ers—as quarterbacked by Brock Purdy for his truly unbelievable 10^{th} straight win. This game featured another amazingly spectacular display of quarterback talent, with Purdy throwing 4 touchdown passes/no interceptions.

After this 49ers-Dallas game, Brock Purdy now has the highest quarterback rating of any quarterback of the 32 teams comprising the National Football League. And this includes acknowledged superstar quarterbacks, such as Patrick Mahomes, Josh Allen, Tua Tagovailoa, Lamar Jackson, and Joe Burrow [whose salary is 55 times more than that of Purdy].

Brock Purdy is an absolute Cinderella wonder, having gone from ‘Mr. Irrelevant’ to currently the highest-rated quarterback of all the National Football League quarterbacks. How is this possible when Purdy was such a lowly—essentially a throwaway—dead-last draft pick in the entire 2022 draft? ‘Who would have thought it’—NO ONE! To honor his amazing performances, Purdy has now been voted one of the San Francisco 49ers six captains.

“It just shows you how guys respect him and how he is a natural-born leader,” All-Pro left tackle Trent Williams said. “To me, that's a huge notch on Brock Purdy's belt to have the respect of your teammates. It's not like he's been the day one starter. It's not like they handed him the keys to the car. For him to be able to start where he did last year around this time and to be 12 months later a captain of the team and starting quarterback, I think it just says multitudes about him and his love for the game and his ability to lead.”

Flash update 2: Oct. 12, 2023—A full-color photograph of Brock Purdy appeared on the front page of the Wall Street Journal with the headline: “BROCK PURDY IS THE NFL'S MOST VALUABLE PLAYER . . . ” and in the WS Journal section (A) you will find a large full-color photo of Purdy along with a half-page editorial extolling this remarkable athlete—who, in essence, came from nowheresville. His salary was mentioned: Purdy's salary for an entire 17-game football season is what Joe Burrow of the Cincinnati Bengals makes in a 15-minute quarter of a single game.

It is a fact that Purdy is the best financial deal in the entire National Football League—and no one anywhere on earth would have recognized his sensational talent and leadership qualities. ‘Mr. Irrelevant,’ Brock Purdy, was drafted—at best—as a 3^{rd} string or 4^{th} string backup quarterback—and most certainly not as the NFL's most valuable player not only at quarterback, but at any position. For reference, the NFL has 1,696 players.

How do you explain this magically phenomenal success of ‘Mr. Irrelevant’—the last player taken in the National Football League 2022 draft? Simple answer: You can't!—at least not by the methodology currently used to draft NFL quarterbacks!

It is very bad news to get a high quarterback draft pick wrong—the story of 3 disasters: Here is a major disaster when getting the quarterback wrong: In signing to a contract an expensive high-draft-choice quarterback [and the high-draft choice quarterbacks are always expensive, especially if they are first-round or second-round picks], and then this quarterback goes on to be ‘bust’—the team in question has been disastrously handicapped.

Then, there is the ‘hit’ against the team's salary cap. Currently set at $224.8 million total spend for each team per year, if a quarterback who fails to produce chews up, say, $30 million of that salary cap, this leaves less money available to afford elite athletes at other positions to somehow, in some way, rescue the team by compensating for the huge fiasco of having chosen what was believed—wrongly as it turns out—to be the quarterback leading the team to the Mount-Everest-like mountaintop: VICTORY IN THE SUPER BOWL! This previously envisioned/hoped for/prayed for quarterback was not able to answer the call of duty and that is to WIN This is a major disaster for certain!

Yes, it is a fact that it is all but impossible to win the Super Bowl by having only the 2nd, 3rd, and 4th-string quarterbacks. So, what happens? Another year mired in ho-hum mediocrity. Another year of disgruntled fans. Another year where the thrill and the joy of a Super Bowl victory has evaporated. No Holy Grail—only the bitter plum and the agonizing pain of losing. What might have been, could have been, should have been . . . gone with the hopes and aspirations of totally frustrated owners and coaches, and most certainly millions upon millions of die-hard fans. And for the losing teams, the off-season is very, very long, indeed—an abyss of despondency.

Here is yet another disaster when an elite quarterback draftee does not pan out. And that is the team drafting this elite college quarterback often has to ‘trade up’ in the NFL draft by forfeiting valuable draft choices to ‘acquire’ the draft choice high enough to facilitate obtaining this 1^{st} or 2^{nd} round quarterback.

So, that's three disasters: The First Disaster: the quarterback is a bust and not the hero lifesaver as sincerely hoped and paid for. The Second Disaster: the ‘hit’ against the salary cap, as described above. And now comes the Third Disaster: the forfeited draft choices, which could have filled other positions of need, are now gone as with the winter wind blowing off the icy Great Lakes. Again, that's three huge Disasters—enough Disasters to have a large jar of Turns on the left side of the desk, and a large bottle of Advil on the right side . . . .

And even at a lower level, colleges with ‘fanatical’ National Championship aspirations—such as most certainly Alabama, Clemson, Georgia, USC, The Ohio State, LSU, Notre Dame, and so on—also want answers as they rate top high school quarterback prospects for performance potential at the higher college level. Of note is that coaches can get fired even with winning seasons at some prestigious schools. The point is this: Having a second-rate quarterback at ANY level of play—high school, college, or the professional National Football League—usually spells doom for that team.

As we have emphasized herein, the very serious—and often astronomically expensive—challenge with the current prior art for NFL quarterback draft section is that no one currently knows definitively and in advance of actual on-the-field playing time how such-and-such a top quarterback prospect will actually perform when under fire, so to speak, at the next highest level. And there is no higher level than the National Football League where WINNING is the ONLY consideration. Nothing else matters in the world of the NFL, where LOSE is a forbidden word.

Thus, the extremely vital question for a successful NFL quarterback draft pick is this: Can something be done to mitigate the very real possibility-even the likelihood, as it frequently turns out—of a ‘bust,’ in view of the fact that there are so many very expensive NFL high draft-pick quarterback ‘busts’? National Football League owners whose pocketbooks are frequently burned to the tune of millions of dollars, or even hundreds of millions, desperately desire to have the answer to this question.

It is an incontestable fact that without a great quarterback, the vision of Super Bowl victory is an impossible mirage—a veritable quicksand of despair, a fetid swamp of hopelessness, a Heartbreak Hotel of broken dreams.

But finding this ‘great quarterback’? Again, quoting Hall of Fame Head Coach and offensive ‘genius’ Bill Walsh of the San Francisco 49ers: “Few men are qualified to evaluate the quarterback position.”

Therefore, the searing and currently unanswerable question posed by one and all is this: Is there a better way to sift meaning from the murky fog of huge data metrics to determine who will become a winning quarterback in the National Football League? Yes, there is!

### Brief Glossary of Football Terms:

1. The football playing field is 100 yards in length from one end to the other end, with chalk-line markers at every 10-yard interval.

2. However, each end of the field has additional territory of 10 yards called the ‘end zone.’

3. The term ‘goal line’ represents the demarcation line between the end of the playing field and the end zone.

4. Thus, there are two ‘goal lines,’ one on each end of the 100-yard playing field.

5. And each goal line is 50 yards from the midline of the 100-yard playing field.

6. Each team is assigned one of the goal lines to defend.

7. Each team has two squadrons of players-those on the ‘offense’ and those on the ‘defense’—and the offense players and the defense players have contrasting skill sets.

8. On the playing field at any given time, the offense consists of 11 players on one team, and the defense consists of 11 players on the other team.

9. When a team has ‘possession’ of the football, this means that the offense of that team has been given the opportunity to advance the football toward the opponent's goal line.

10. And the team attempting to keep the offense from advancing the football is the defense.

11. When on offense, the team is given four ‘downs’ (meaning four attempts) to advance the football toward its opponent's goal line a minimum of 10 yards from any given starting point on the playing field.

12. The given starting point of play on the field is called the ‘line of scrimmage.’

13. Failure in 4 attempts to advance the football a minimum of 10 yards from the line of scrimmage results in the team on offense no longer being allowed to continue on offense.

14. On the other hand, if the offense is successful and does in fact advance the position of the football 10 yards (or more) during its allotted 4 downs, the offense is given a ‘first down.’

15. A ‘first down’ means that the offense has 4 more attempts (‘downs’) to advance the football another 10 yards, or more, if possible.

16. Whenever unsuccessful to gain a first down (i.e. a minimum of 10 yards from the original line of scrimmage), the 11 players on offense are then sent to the sidelines.

17. The 11 players on defense, who have been on the sidelines, now take to the playing field.

18. Points are scored when a team crosses its opponent's goal line while carrying the football, or by having a player catch a ‘pass’ (i.e., catching a football which has been thrown) in the opponent's end zone.

19. Crossing the goal line with the football in hand, or catching a pass in the opponent's end zone, results in a score, called a ‘touchdown.’

20. The team scoring a touchdown is awarded 6 ‘points.’

21. Of course, each team defends its own goal line super-vigorously with all its might—so that the opposing team is deprived of scoring a touchdown, thus denying the opposing team points.

22. To protect the quarterback from the relentless onslaught from the defensive players, who are akin to huge lions on the attack, offensive ‘linemen’ are gigantic behemoths [and often very intelligent], almost always weighing 275-350 pounds.

23. The offensive linemen position themselves along the line of scrimmage and as much as possible function as a wall of granite to give the quarterback time to either: 1. hand off the football to a running back; 2. pass the football to an intended receiver; 3. run with the ball himself (called a ‘quarterback sneak’).

The above glossary is a brief synopsis of American-style football, which interestingly is called ‘football.’ [′Real′ football, of course, is soccer, where the use the hands is not allowed!]

This Background is provided to introduce a brief context for the Summary and Detailed Description that follow. This Background is not intended to be an aid in determining the scope of the claimed subject matter, nor be viewed as limiting the claimed subject matter to implementations that solve any or all of the disadvantages or problems presented above.

### SUMMARY OF THE INVENTION

The position of quarterback in the National Football league (NFL) is the most difficult of ANY position in ANY sport to determine in advance of actual NFL playing time how well a drafted quarterback will perform in the NFL.

Superior talent at the position of NFL quarterback is vital for winning what is considered by many to be the most coveted prize in all sports: The SUPER BOWL! Nothing else compares to the glory and resounding status of a Super Bowl victory, except possibly the World Cup in soccer.

But how to determine in advance of actual National Football League on-the-field playing time how such-and-such a college player will perform at the NFL level is a huge enigma, often confounding the very best scouting minds in the business. As stated emphatically herein, busts abound—and especially at the quarterback position! And NFL quarterback busts are very expensive busts, indeed—not only financially, but also resulting in many zeros (‘goose-eggs’) in the win column.

It is true that coaches and scouts who analyze potential NFL athletic talent at every position attempt to consider anything and everything which is believed to influence a prospect's ultimate athletic performance in the NFL.

But weighing the relative, and often very subtle importance of these numerous variables (‘metrics’) from one potential NFL quarterback prospect to another is uncannily difficult for human beings, who have their own backgrounds, and their own personal biases, both of which can definitely influence the final yes-draft-very-high/no-don't-draft-very-high/no-don't-draft-at-all decision for a particular athlete.

And the same can be said of other positions in football at the National Football League level, although not nearly to the same degree of performance uncertainty as with the position of quarterback. With quarterbacks, it is truly an enigma who, after being drafted, will ultimately perform in the NFL at the hoped-for level, and who will be an expensive bust.

Yes, the use of computers has certainly become helpful in analyzing athletic ability in certain sports—such as in baseball, a game in which the metrics are quite basic and easy to computerize (batting average, pitcher velocity, pitcher accuracy, ability to get ‘hits’ with men on base, etc.).

It is a fact that many professional Hall of Fame major-league baseball players were ‘phenoms’ in their teenage years, and it was obvious that huge success would be their destinies. Why was it obvious?

For instance, if a pitcher in college or high school can consistently throw at 90 miles-an-hour, and even faster—and can throw ‘strikes’ at will—and has a good curve ball and/or sinker—or both—and is a durable, big-strong kid, it does not take Artificial Intelligence, or a psychic mind-reader with Tarot cards, to determine that this athlete is a solid major-league baseball prospect—and most likely is not a ‘bust’. A pitch velocity analyzer and a pencil and paper, or a hand-held calculator or laptop computer, in the hands of a seasoned scout in the stands is all that is really required. And likewise, if an otherwise excellent hitter at a lower level has trouble with curve balls and other ‘breaking’ pitches, forget it! He is not going to be a major-leaguer, and the only way he will watch big-league games is on television or by purchasing a ticket.

For further comparisons, let us now consider other sports, as we have above for baseball, such as tennis and golf.

Tennis champion Roger Federer won 4 junior singles titles while a teenager, including the Junior Wimbledon championship. It was obvious that he was destined for greatness. In his phenomenal career, Federer went on to win 104 singles titles and 20 Grand Slams titles. For all practical purposes, he is said to have ‘owned’ Wimbledon, with 8 singles Wimbledon Grand Slam titles.

Next, let's look at golf: Tiger Woods won 3 U.S. Junior championships, and as Federer dominated professional tennis, Tiger Woods went on to dominate professional golf. From a young age, greatness was his destiny. Again, it was obvious.

Here are other points to take into consideration with baseball, tennis, and golf. In baseball, there is at any one time only one ‘pitcher’ and only one ‘batter’—i.e. a very straightforward situation. Then, there are ‘fielders’ to catch the ball, but no one is knocking these fielders to the ground, as in football. No, baseball is an unelaborate game. With tennis, there is one player on one side of the net, and one player on the other side of the net—again, very simple. Even with ‘doubles’ tennis, there are only two players on one side of the net, and two players on the other side of the net—what could be more straightforward and lacking in complexity? And, as in baseball, no one is knocking these tennis players on their derrières. In golf, the ball is not moving before it is hit with the golf club. No one is bumping or running into the golfer, or interfering in any way with the golfer's ability to hit the golf ball.

In these sports—tennis, golf, baseball, and others—the use of computers, while somewhat helpful, is not essential for evaluating the talent of a youngster destined for the big-time professional arena. The addition of Artificial Intelligence in these sports, while imparting ‘sizzle,’ does not improve the prediction accuracy to any real degree. The talent is obvious even for a novice, unsophisticated sports fan to witness. Fame awaits these youngsters!

Now, returning to football, you have 22 players all running around the field maniacally (or so it seems), often in different directions, and joyfully and ultra-vigorously knocking each other down. However, there is a great amount of intelligent and well-thought-out strategy for every single play—and very specific instructions for every single player—and this means for the 11 players on the offense side of the ball, and for the 11 players on the defense side of the ball—as the two teams line up facing each other along the line of scrimmage.

Particularly enjoyable to fans are the often-colorful names of plays, such as ‘Hail Mary’/‘Immaculate Reception’/‘Flea-Flicker’ (one of the co-inventor's very favorite offensive strategies), etc. Several other of the very numerous plays used on offense include ‘Hook/Hitch,’ ‘Slant,’ ‘Play-action,’ ‘In/Drag/Dig,’ ‘Screen,’ ‘Double Wing,’ etc. Football is an intricate game of strategy and counter-strategy, and is akin to war except, fortunately, without actual killing. Thus, what appears at first glance to be ‘disorganized mayhem,’ or essentially a ‘free-for-all,’ is not in the least ‘disorganized,’ or a ‘free-for-all.’

And there are dozens of rules of conduct, which are strictly enforced with penalties, or even with expulsion of a player from the game for such egregious infractions as leading a tackle with the helmet (‘targeting’). This complexity is not at all apparent to those who are unfamiliar with American-style football. Indeed, football is one of the most complex of sports.

Also, in the National Football League—unlike tennis and golf, where the audience is warned that they must be as quiet as church mice—you have many tens of thousands of screaming fans. And some of them go to games just to scream their heads off—and this is no exaggeration! The purpose of this incessant hollering is to rattle the opponents into making mistakes, adding to the pressure and the difficulty of players to perform—especially for the quarterback, and most certainly at the loudest stadium of them all—Arrowhead Stadium in Kansas City. [How loud is it at Arrowhead Stadium? In 2014, Arrowhead Stadium set a Guinness World Record for its stadium noise against the New England Patriots. The fans were so loud that they registered the sound at 142.2 decibels. That's louder than a jet plane taking off.]

Focusing on the key question which reduces the drafting of a NFL quarterback to odds often similar to a dice throw in Las Vegas: What is so unique about the supremely important National Football League position of quarterback?

The difficulty is related to the fact that, for the position of NFL quarterback, the calculus is very different and far more complex than in baseball, or in golf, or in tennis (as discussed above) or just about any other sport, for that matter. Why? Because there are so many, many often very subtle intangible variables at the position of quarterback—more variables in fact than at ANY other position in ANY other sport—and that includes other football positions, such as lineman, running back, defensive back, and wide receiver. And nowhere is this more evident than at the very highest professional pinnacle—namely, the National Football League.

It cannot be overemphasized that there is something peculiar and uniquely different about the position of National Football professional quarterback when compared, for instance, to the quarterback position at lower levels (college, generally)—or when compared to all other football positions.

For instance, wide receivers in college who are top-tier athletes generally continue to perform as top-tier athletes in the NFL. Likewise, linemen, defensive backs, and running backs who are stars at the college level are very likely to continue to be stars in the NFL—and, in fact, are often selected as ‘All-Pro’ National Football League standouts.

Why is this not the case with NFL quarterbacks? It is because for linemen, wide receivers, defensive backs, and running backs, the college football game is essentially similar to the professional football game, except that the athletes are better and faster in the NFL.

Yes, computers can certainly be helpful in evaluating NFL positions other than quarterback. But the decision-making process is easier and less convoluted for these other positions. This is because with positions other than quarterback, the athletes are playing essentially the identical game at the college level and at the NFL level.

This is NOT the case with the position of NFL quarterback. Why is this? As emphasized herein, the position of NFL quarterback is hugely different from any other position in football. For instance, the college quarterback and the NFL quarterback are, in fact, playing two different games: Game 1) the quarterback position at the college level; Game 2) the quarterback position at the National Football League level. It can be likened to chess and checkers. Both utilize the same playing game-board, but are vastly different games.

Playing quarterback at the college level is, so to speak, playing the simpler game of checkers, while playing quarterback at the National Football League level is playing chess, a much more difficult and complicated game to master.

Another analogy involving mobility and spontaneous decision making can be made as follows: Does someone proficient in driving a car have the innate ability to successfully fly an airplane (even after extensive flying lessons), which is a far more complex task to accomplish? This is impossible to determine without actual real-world performance of having this individual actually fly an airplane—hopefully without crashing or even getting killed.

As it turns out, playing decisions at the NFL quarterback level must be made with much less time for thinking and deliberation than what is available for such decision making in the college football game. Multiple options must be instantaneously processed by a National Football League quarterback. And windows of opportunity, such as an ‘open’ receiver, close fast, usually in just a few seconds, or even in milliseconds!

There is no luxury—such as ‘let me mull this over for a while’—for a quarterback in the National Football League. And wrong decisions by an NFL quarterback are instantly punished by the uniformly outstanding athletes on the defensive side of the ball. It is a fact that there are no ‘bad’ players on any National Football League defensive squad.

As strongly emphasized in this disclosure, regardless of the talent of the football players on an NFL team other than quarterback, the Holy Grail of victory in the Super Bowl is impossible without a truly game-winning quarterback. This is why quarterback Patrick Mahomes of the Kansas City Chiefs and winner of two Super Bowls recently signed a long-term contract for $450 million dollars. And this is why quarterback Lamar Jackson, considered capable of winning Super Bowls for the Baltimore Ravens, just signed a $52 million dollars per year contract. These are lofty numbers, indeed!

Again, for the position of quarterback at the college level and for the position of quarterback at the NFL level, these are essentially two very different positions. And to the deep consternation of NFL owners and coaches, the talents of a college star quarterback may not—and, sadly, often do not—translate into success in the National Football League. Currently, much ‘guesswork’ is involved in drafting college quarterbacks into the NFL, with a plethora of subjective decision making.

And there is no question that costly quarterback draft failures are the very worst disaster for a National Football League team. For the position of NFL quarterback, the draft can be an unfathomable morass, a dank swamp where failures abound—very often a bridge too far.

So, what can greatly improve the accuracy of predicting quarterback winners at the NFL level, based upon analyses of quarterback winners at the college level, and upon comparative analyses of quarterback winners at the NFL level—keeping foremost in mind the gigantic number of individual metrics which can affect on-the-field quarterback performance in either instance?

A salvation for this frustrating and extremely challenging quarterback National Football League draft conundrum is the Artificial Intelligence model of the present disclosure—which employs freeze-frame video data acquisition and AI analyses, correlations, and cross-correlations to sift through a gargantuan number of metrics to find meaning which can ultimately determine future NFL quarterback greatness. And why is this essential?

Because what really matters in the National Football League is very simple: WINNING! To quote the famous Al Davis, the late owner of the Oakland (now Los Vegas) Raiders NFL team—“JUST WIN, BABY, JUST WIN!” Truly—WINNING is the ONLY thing that matters in the world of all high-profile sports, and most intensely, in the National Football League. And without a ‘star’ Super-Bowl caliber NFL quarterback guiding the ship, “JUST WIN, BABY!” although a punchy and clever slogan, most often results in on-the-field disasters—and many zeros (‘goose eggs’) in the win column.

Yes, National Football League owners are rightfully and determinedly focused on winning Super Bowls, and anything less is a bitter plum. NFL owners are winners in life with enormous ‘street’ credibility and huge prestige, and these extremely successful giants of industry naturally wish to keep right on winning.

And it is a fact beyond questioning that anything less than a brilliant NFL quarterback means an also-ran team. National Football League owners-who have in ALL endeavors throughout their entire lives dedicated their hearts and souls to the supreme commitment to winning—AND HAVE WON—simply cannot abide the ignominious mediocrity associated with a losing team. For the owner of a National Football League team, winning is everything—DEFEAT IS NOT AN OPTION! Quoting the Green Bay Packers' tough-as-iron Head Coach Vince Lombardi: “Defeat is worse than death, because you have to live with defeat.”

Drafting a sensational college quarterback who has the phenomenal talents which can be effectively translated and carried forward to win at the very highest level-namely, the National Football League (NFL)—is exceedingly difficult with the current art, and, unfortunately, is often fraught with very expensive quarterback failures (‘busts’).

However, by applying the present disclosure's Artificial Intelligence (AI) video freeze-frame modalities to the truly colossal list of variables between NFL prospective quarterbacks at the college level—and making comparisons of these college quarterbacks with winning NFL quarterbacks, the accuracy of the ultimate decision being the correct one is significantly enhanced.

Freeze-frame video analyses using AI: The present disclosure greatly improves the ability to judge a college quarterback for his potential in the National Football League by employing data acquisition using Artificial Intelligence applied to freeze-frame video technology. Herein details some of the ways this AI data acquisition freeze-frame technology works, and how it can be applied to actual practice by NFL coaches, owners, and talent scouts:

1. The top level of college football is called Division 1, comprising 133 teams.

2. Division 1 college football is given the most scrutiny by the very highest level-namely, the professional National Football League, comprising 32 teams.

3. The quarterback is the captain of the ship and is—by far—the most valuable member of each team.

4. The position of quarterback is of such importance that the destiny of winning, or of losing, depends greatly on the talents, or lack thereof, of the team's quarterback.

5. Therefore, in each yearly draft of collegiate athletes, the 32 NFL teams compete relentlessly to select the very best quarterback(s) possible.

6. In a typical Division 1 college football game, the quarterback throws between 25-50 times, called ‘passes.’

7. And there are typically 11-12 games in a college football season.

8. Thus, and assuming 12 games, each Division 1 team throws during the football season between 25×12=250 passes, and 50×12=500 passes.

9. Most Division 1 college games are televised, often not nationally, but nevertheless each game—and every single play of each game—are available for video observation and analyses by National Football League coaches and talent scouts—i.e., most definitely smart Professionals, but nevertheless human beings.

10. Almost all football passes are made by the quarterback.

11. And the huge majority of big-yardage plays—such as 30-60 yard plays—which advance the position of the football closer and closer to the ultimate goal of scoring a ‘touchdown’ by crossing the goal line and thereby putting 6 points on the board—are attributed to passing plays.

12. Therefore, for the quarterback position in the National Football League, the most important consideration of all is how successfully this athlete ‘passes’ (throws) the football to an intended receiver, which means first and foremost throwing a ‘catchable’ football.

12. For a typical 12-game football season of The Ohio State University, or of the University of Southern California (USC), or of the University of Georgia, using three perennial college football powerhouses as examples, between 250 and 500 number of passes by the quarterback can be analyzed.

Herein shows how this advanced digital freeze-frame videographic technology can be subjected to the intense Artificial Intelligence scrutiny of the present disclosure for the position of quarterback. And it should be noted that the digital freeze-frame videography/AI methodologies described in this present disclosure are generally applicable for football positions other than quarterback (running backs, defensive backs, receivers, and even linemen), but these other positions are not as inordinately complex as is the quarterback position. Nevertheless, all the information which helps prevent draft failures at any position in the National Football League is a huge boon to coaches and to team owners paying the bills.

The ability of a college quarterback who displays sufficient talent that National Football League teams show interest can be effectively analyzed in granular detail using the present disclosure's freeze-frame video technology and Artificial Intelligence analyses, correlations, and cross-correlations.

To successfully complete passes in the face of a tremendous lion-like pass rush by the defense, or to make other great alternative split-second decisions—such as the quarterback ‘scrambling’ for a first-down if all the receivers are ‘covered’ by defensive backs—is a paramount consideration for winning in the NFL. The ability for the NFL quarterback to overcome ALL adversity and hence to WIN is especially critical when the outcome of the game is on the line.

NOTE: With a pass, only 1 outcome is good—and 2 outcomes are bad, and sometimes horrifically bad:

1. The pass is ‘complete,’ meaning that it is caught downfield by the team's receiver—wonderful!

2. The pass is ‘incomplete,’ meaning that the pass is not caught, with the penalty a loss of a ‘down’—usually not devastating or the end of the world as we know it, but still a bad result.

3. The pass is caught by the OTHER TEAM! This is called an ‘interception,’ and many games have been lost because of the devastating results of an interception. Losing like this—in the NFL—IS the end of the world!

Therefore, anything less than a truly superlative college quarterback passer is instantly eliminated from NFL draft contention, as this quarterback cannot win football games at the NFL level. And winning is the ONLY THING WHICH MATTERS IN THE NATIONAL FOOTBALL LEAGUE!

### Video Data Acquisition/AI Module—How it Works:

The instantaneous frame-by-frame ‘freezing’ capability of advanced digital videography and television systems can be used to great advantage utilizing the present disclosure's Artificial Intelligence to analyze, correlate, and cross-correlate in enormous detail hundreds of quarterback plays—or the plays of any other football position, for that matter—of any given college team throughout the entire season.

And the same freeze-frame video/AI technology of the present disclosure can be employed for analyzing, correlating, and cross-correlating outstanding NFL quarterbacks. In so doing, comparisons can be made between the college quarterbacks of interest to the NFL and actual real-live National Football League quarterback ‘stars,’ such as Josh Allen of the Buffalo Bills, and Joe Burrow of the Cincinnati Bengals.

As the first step, NFL coaches and talent scouts can obtain videos of all the games played by a quarterback in whom they express an interest (usually 11-12 games)—and certainly videos of the ‘starting’ quarterbacks (i.e., the athlete who begins the game at the quarterback position) for top college teams. An excellent beginning is with videos of the top 25 nationally-ranked Division 1 college teams.

In addition, to take maximum advantage of the present disclosure's freeze-frame video data acquisition/AI analyzes, comparisons, correlations, and cross-correlations, it is wise not only to assess the quarterbacks starting for the top 25 Division 1 college teams, but also to search for quarterbacks who are ‘Sleeping Beauties’—that is, who are outstanding and are making names for themselves, although their teams are not nationally ranked, and may not even be Division 1 college teams.

For the most valuable freeze-frame video data acquisition/AI analyzes, comparisons, correlations, and cross-correlations, voluminous data observations can be made for every single pass play made during the entire season by the quarterback garnering NFL draft interest (typically 250-500 passes/season).

And similar freeze-frame video data acquisition/AI analyzes can be made for plays in which the quarterback intended to pass, but the pass was aborted because of unfavorable circumstances, such as receivers not being ‘open’ to receive a pass, or a ferocious ‘blitz’ by the defenders which threatens to tackle (‘sack’) the quarterback, to name several examples.

Employing a large-screen video monitor or television system (such as an 80-inch Samsung TV), extremely detailed data—including the most minute details of every single pass, or of other plays of interest—can be made by freeze-framing the video frame-by-frame and recording the results.

Although at first glance this appears to be a particularly onerous task, the fact that the total time comprising actual football play action is 15-20 minutes per game, with games lasting up to 3+ hours. And approximately 50 percent of this playing time is when the quarterback and the rest of the offense squad are on the sidelines resting, while the defensive squad takes the field.

### Basic Quarterback Video Data Acquisition Points:

Video data acquisition questions to be answered and recorded on every selected play (and select all the passing plays for maximum AI validity) include—but are not limited to—questions such as these:

1. Was the pass successfully caught by the intended receiver?

2. Was the pass incomplete, and not caught by the intended receiver?

3. Was the pass intercepted by the opposing team (a catastrophe—with as many as 75,000 fans in the stadium groaning and screaming, OH NO!)?

4. Was the pass aborted and not thrown? Why?

5. Very importantly, HOW MUCH TIME was given to the quarterback to throw the pass (such as 2.75 seconds, or 4.25 seconds, for example)? It is a fact that if you give an outstanding quarterback the luxury of sufficient time, he will pick your defense apart. Your team's defense will be annihilated. Thus, causing the quarterback again and again to hurry the throw, or disastrously to even fumble the football, or allowing himself to be ‘sacked,’ (i.e., tackled) is the best possible strategy for neutralizing even a superior quarterback. And in so doing, your defense will be wonderfully rewarded by picking off passes (‘interceptions’), or by causing incompletions, or causing quarterback fumbles, or quarterback ‘sacks.’

The defensive pass rush in the NFL is always relentless, with defenders ‘licking their chops’ to tackle the quarterback and throw him to the ground for a ‘sack.’ And with the bonus for sacks in the National Football League generally being so very lucrative—such as five sacks=$500,000, and 10 sacks=$1 million—it is easy to appreciate that the pressure is excruciatingly intense for the NFL quarterback to get the pass launched and into the air.

Does the college quarterback who is a potential-NFL draft pick have the ability to make an instantaneous and correct passing decision with no time whatsoever for dawdling or thinking things over? Having this innate talent is mandatory for success in the National Football League. And not having this talent spells doom and abject failure. In fact, the best decision may be NOT to pass at all, but to run with the football, if circumstances warrant.

6. What was the distance of the pass? Longer passes are much more difficult to complete—and entail much greater risk—than short passes, as longer passes are easier for the defender to bat down for an incompletion, or to catch for an interception. With the pressure of many tens of thousands of people watching (and usually hollering at the top of their lungs to bamboozle the quarterback and force bad decisions), completing long passes takes consummate skill and truly exceptional confidence in one's abilities.

7. What was the velocity of the pass, and how long was the pass to the intended receiver in the air? Throwing a pass at the optimum velocity for the receiver to catch is the hallmark of a winning National Football League quarterback. The college quarterback must have this skill to be considered by the NFL. Throwing a blazingly fast football can often lead to the receiver being unable to catch the football. On the other hand, there are times when the quarterback must put some real pace on the football and throw a zinger of a pass, especially for a short-to-medium distance pass when the receiver is well covered by the defense.

The trajectory of the pass is very important. If the pass is thrown at too low a trajectory, a defending lineman can knock the pass down at the line of scrimmage—or a linebacker down field is presented with a very rewarding opportunity to knock down the pass, or to intercept it. Indeed, throwing a pass which ‘hangs’ in the air is dangerous. This means that a successful quarterback in the NFL must have an instinctive ‘feel’ not only for how fast to throw the football, but at what trajectory angle required to complete the pass to the intended receiver. The winning NFL quarterbacks all have this essentially innate/inborn talent. College quarterbacks who do not have this ability are unsuitable for the National Football League.

8. What was the distance between the intended receiver and the nearest defender? Meaning how physically close was the defender (or defenders) to the receiver? Of course, if the defending linebacker(s) are doing a great job, they are running right next to the receiver, making a pass completion very difficult—and very risky.

9. How many defenders were ‘covering’ the receiver (meaning being in very close proximity to the receiver, such as 1-2 yards) to thwart the pass from being caught by knocking it down, or being in a position to intercept the intended pass? One defender? Or ‘double-teamed’ (meaning 2 defenders)? Or even ‘triple-teamed’ (3 defenders)? It is often the case that super-talented ‘All-Pro’ receivers are double-teamed, and sometimes even triple-teamed.

Further Video Data/AI assessments of quarterback skills:

1. Passing accuracy. Passing accuracy is the sine qua non for a quarterback to be successful in the National Football League. If a quarterback cannot throw with extreme accuracy—especially when the pressure to perform is maximum—such as with the game on the line—and when the intended receiver is very closely ‘covered’ by one defender, or double or even triple-teamed by multiple defenders—and the quarterback is given very little time because of a ferocious pass rush by the defense—and the crowd noise is off the charts LOUD—and the quarterback panics and repeatedly makes terrible decisions, such as throwing interceptions, this is an instant no-draft decision by NFL coaches and scouts.

Pass interceptions by the defensive team often lead to the disaster of losing the game. Passing accuracy is something akin to ‘threading a needle’—with no room for error. Exceptional NFL-draft-worthy college quarterbacks have this ability, but most college quarterbacks do not.

Here is one example of a quarterback with astounding passing accuracy credentials over many years in the NFL: Drew Brees of the San Diego Chargers and the New Orleans Saints (derogatorily called the ‘Aints’ after the Saints lost their first 14 games in 1980, prompting sportscaster “Buddy D” Diliberto to advise Saints supporters to wear paper bags over their heads (‘bagheads’) at the team's home games; many bags rendered the club's name as the “Aints”—rather than the “Saints.”)

Drew Brees changed all this, even bringing a Super Bowl victory to the New Orleans Saints, a game in which he was the Most Valuable Player (MVP). Now, to the resounding pleasure of everyone in New Orleans, the Saints are a highly-respected NFL team.

Drew Brees is one of the most accurate passers in National Football League history. Therefore, using Drew Brees as a magnificent benchmark for NFL quarterback passing accuracy, the present disclosure's AI technologies applied to freeze-frame video technology can assess in granular detail several seasons for this remarkable NFL quarterback. These data can then be utilized for comparisons with potential NFL-draft-worthy college quarterbacks.

Certainly, other outstanding NFL quarterbacks can be compared with college quarterbacks by utilizing the video freeze-frame/AI model described herein. And many other metrics of NFL quarterbacks and college quarterbacks can be subjected to comparisons by the AI-trained analyses, correlations, and cross-correlations according to the present disclosure. These include physical metrics, emotional metrics, background metrics, and other important metrics.

For instance, the sensational career of Aaron Rodgers while quarterback of the Green Bay Packers would be another excellent choice for complete AI-modelled analyses, correlations, and cross-correlations as per the present disclosure—and then comparing all these numerous metrics to those of college quarterbacks thought to have NFL potential. Rodgers was voted the league Most Valuable Player (MVP) by the Associated Press for the 2011, 2014, 2020, and 2021 NFL seasons. This is especially remarkable because of the ten-year span from the first to the fourth MVP awards.

And, of course, the AI-trained module of the present disclosure can be very intelligently utilized for the full metrics of Tom Brady—the Greatest of All Time (‘G.O.A.T’).

Thus, very helpful to coaches, owners, and talent scouts are the present disclosure's AI-modelled metric comparisons of superlative NFL quarterbacks-such as Drew Brees, Aaron Rodgers, and Tom Brady—and then comparing their NFL metrics with the metrics of college quarterbacks who are garnering serious interest from National Football League teams.

And for comparison with a current college quarterback, similar AI-modelled data video analyses, correlations, and cross-correlations can be employed for the college statistics of the University of Southern California's starting quarterback, Caleb Williams. Williams won the Heisman Trophy in 2022 as the best college athlete at ANY position. After the 2023 season ends, Williams will quite likely be chosen as the Number One draft selection in the 2024 NFL draft. Over the next few years, it will be interesting to see how well Caleb Williams ultimately performs in the National Football League.

2. Ability of the quarterback to pass on the run. To gain precious time to pass, quarterbacks in the National Football League have the talent to throw passes while running to the left of the ‘pocket’ immediately behind the center lineman, or to the right. For a right-handed quarterback, running to his left and throwing an excellent pass takes tremendous ability, as this quarterback is throwing ‘against the grain’ (meaning being in an awkward position to pass effectively, especially to a receiver who is downfield on the right side).

3. Ability of the quarterback to also function as a ‘running back.’ A rare and incredibly talented quarterback can function as a superb running back, meaning that this quarterback can ‘tuck’ the football tightly in his arms and sprint downfield-often to gain huge yardage. This, of course, is bedeviling to the defense, as now defenders must be concerned not only with the passing abilities of this quarterback, but also his football-carrying ‘running-back’ abilities. Very successful running-back quarterbacks in the National Football League include Patrick Mahomes of the Kansas City Chiefs, and Lamar Jackson of the Baltimore Ravens.

College quarterbacks who have both passing and ‘running-back’ talent are given especially serious NFL draft consideration. However, the drawback for a quarterback who leaves the protection of the ‘pocket’ immediately behind the center lineman and is now a ‘running back’ is that the defenders ‘lick their chops,’ and attack mercilessly and with maximum force this ‘running-back’ quarterback. This is a punishment for the conceit that this quarterback can at will become a ‘running back,’ and therefore make the defense look inept. Thus, the durability, toughness, and the ability of a college ‘running-back’ quarterback to take a vicious ‘hit’ is of very deep concern for an NFL team drafting this athlete. Leaving the (relative) safety of the ‘pocket’ courts injury for an NFL quarterback. Serious injury to an outstanding first-string NFL quarterback can result in a losing season record for the team.

4. Talents of the intended receiver. What were the talents of the intended receiver for whom the pass is intended?

a. Mediocre?

b. Average?

c. Excellent?

d. Outstanding, meaning NFL-potential talent of this athlete—that is, a college receiver whom in the future you could be watching on TV on Sunday NFL football, or NFL Monday Night Football, or NFL Thursday Night Football?

5. Talents of the pass defender. What were the talents of each defender ‘covering’ the receiver with the purpose of preventing completion of the pass, or intercepting the pass?

a. Mediocre?

b. Average?

c. Excellent?

d. Outstanding, meaning this college athlete has NFL-potential talent?

6. Emotional Pressure Score (EPS). An assessment of emotional pressure on the quarterback is critical, as the ability of a quarterback to ‘shake off’ the pressure and perform at maximum capability is absolutely mandatory in the National Football League. The quarterback who ‘chokes’ or folds under intense pressure is most definitely not National Football League material.

For instance, the emotional pressure score (EPS) of the quarterback for each pass throughout the season can be graded on a score of 1-10, wherein 1 is no pressure, and 10 is immense quarterback pressure.

An example of ‘do-or-die’ level 10 extreme emotional pressure is when the quarterback must perform—NOW—with the game's outcome on the line. This is usually in the very final moments of the 4^{th} quarter. [Note: there are 4 quarters in a football game, each lasting 15 minutes.]

On the other hand, there is virtually nil emotional pressure when the outcome of the game is essentially decided. An example of nil pressure is late in the 4^{th} quarter in which the team going on to win is wiping out its opponent, such as by a no-contest score of 50-14.

7. Situational Awareness (SA). A quarterback who at the college level shows exceptional Situational Awareness—and who has outstanding physical, mental, and emotional talents—is a quarterback who will receive much draft attention from National Football League coaches, owners, and scouts.

Quizlet defines Situational Awareness most accurately as follows: “The ability to recognize any possible issues once you arrive at the scene and act proactively to avoid a negative impact.”

Here are examples of individuals who have little or no Situational Awareness—the person who leaves the hot water running in the sink after shaving, or the person who has lived in the same house for 25 years, yet cannot name the street one block away. And here are examples of excellent Situational Awareness—Formula One race car drivers, jugglers able to juggle 6 bowling pins, and, of course, successful National Football League quarterbacks who win many, many games. Taking Situational Awareness to the infinitely more serious plane of life-and-death: Those elk in Yellowstone which exhibit round-the-clock/24-hours-a-day/hair-trigger/life-saving Situational Awareness when sensing the presence of a pack of wolves are the ones much less likely to become dinner.

Situational Awareness as exhibited by a quarterback is his ability to see the entire field, and then complete a pass to the receiver who is in the best position to catch the pass. In the National Football League, a total of 6 players are eligible to catch passes, while the other 5 players are not allowed to be pass receivers. Thus, an outstanding NFL-caliber quarterback will be able to simultaneously see 6 potential receivers, and then pick out the receiver who is in the best position to catch a pass. This talent cannot be easily taught, as it is innate and almost magical.

Therefore, the winning quarterback at the NFL level must possess the absolutely essential ability to see and then to process multiple options at once—and then instantaneously and correctly in only a very few seconds pick out the best course of action. A college quarterback lacking outstanding Situational Awareness will most certainly fail in the National Football League.

8. And the quarterback who fixes his gaze continuously on only one particular receiver while ignoring other potential receivers will also fail in the NFL, as this quarterback is ‘telegraphing’ to the defense exactly to whom he intends to throw the pass.

To elaborate, success in the National Football League requires the quarterback to frequently ‘look off’ one receiver, and then throw a perfect pass milliseconds later to another receiver. This is confounding to the defense, as now the defensive players must cover all the potential receivers. And in so doing, the defense is spread out on the playing field, thus making double-teaming, or triple-teaming, a receiver very difficult and fraught with danger, as multiple-teaming a potential receiver leaves other receivers uncovered and open for a quite easy-to-complete pass.

The talent, the drive to win, and the vast experience of National Football League coaches, scouts—and certainly including NFL-team owners—are enormous, and the work ethic of these truly dedicated human beings is so intense (100+ hour work weeks are typical) that it is almost beyond most people's comprehension. After all, these are Professionals at the very top of the food chain—the National Football League.

However, as with all humans in the final analysis, only a few cross-correlations can be intellectually accommodated at one time—even for the very smartest and the most talented human beings on the planet. Therefore, the infinitely-possible simultaneous AI analyses, correlations, and cross-correlations of the gigantic number of data inputs of the present disclosure enable player selection of a potential National Football League quarterback with far more accuracy and much less guesswork than the current system fraught with uncertainly.

For the quarterback—the most difficult of all positions of all to evaluate for NFL potential—the present disclosure provides great benefit in reducing the uncertainly and the very real possibility of drafting a ‘bust.’

Quoting again NFL Hall of Fame Coach Bill Walsh—‘Very few humans can judge the quarterback position.” The quarterback position is, akin to what Churchill proclaimed when referencing Iron-Curtain Russia, “It is a riddle wrapped in in mystery inside a puzzle.’

### AI Methodology Applied to Freeze-Frame Video Technology.

As mentioned, the AI model must be trained using player data before it can provide useful predictions about future player performance. In a first embodiment, the training data can include analyses of freeze-frame video images of prior games, analyzed and rated by experts, to evaluate athletic performance parameters of the candidate, based on detailed performance metrics on each candidate's specific actions in those prior plays, including the success or failure of each attempted play action by the candidate. For example, by viewing each frame in a stop-action sequence, the expert reviewer can determine critical metrics such as the “release time” required for the quarterback to get rid of the ball after receiving the snap, in each play. The video data can also quantitatively determine the running speed of the candidate at the time of release, a critical ability. Importantly, the video data can also separate those time metrics according to the type of release and passing distance, whether a handoff, a short pass, or a long bomb. The time between ball snap and release, for each type of play, can then be input to the AI model for evaluating the candidate's potential as a NFL starter.

In addition, the freeze-frame evaluations can also provide critical distance measurements, such as the proximity of the ball to the receiver (How accurate was the throw? Did the receiver have to break stride to catch the ball or was it catchable at full speed?) as well as the distance between the receiver and the nearest defender at the moment the ball enters the receiver's hands (the “receiver margin”). A well-thrown ball can maximize that distance. The video data can also quantitatively determine the pass speed and reception angle (that is, the velocity of the ball and the angle of its trajectory at the receiver).

As a secondary distance metric, the video data can readily indicate the “quarterback margin”, the distance between the quarterback and the nearest defender at the moment of release. When the quarterback begins playing in the professional leagues, that distance is likely to shrink.

Based on the evaluation of the expert rater viewing the video frames, the candidate's emotional pressure score can be estimated based on the candidate's clear thinking when confronted with rapidly closing defenders, and the candidate's situational awareness score based on the candidate's ability to track multiple receivers and multiple defenders simultaneously. While these are subjective estimates, experts generally agree as to appropriate evaluations, and those evaluations may be used to train the AI model to provide similar evaluations.

Those performance metrics, and many more derived from the video freeze-frame images, can then be provided as training input to the AI model. For example, the AI model can predict the outcome of the play, and those predictions may be compared to the success or failure of the actions depicted in the freeze-frame. The AI internal variables may then be adjusted to improve the accuracy of those predictions. Then when the AI model has been satisfactorily trained with freeze-frame data, and the other metrics discussed below, it can then provide sufficiently accurate play-by-play success/failure predictions for the targeted players. Those predictions can then be used to evaluate each candidate, or new candidates based on the prior data, and thereby enable more accurate draft decisions.

In a second embodiment, the freeze-frames themselves may be provided to the AI model as training data. For example, the AI model may effectively “train itself” to recognize the action in the frame and to evaluate the performance of the quarterback, or of all the players in some embodiments. During the training process, the AI play analysis and predictions and performance evaluations are then compared to an expert's analysis. If the AI model is right, the internal variables of the model that were most involved in reaching the correct conclusions may be incrementally “hardened” or made more resistant to variation in subsequent training, whereas if the model is wrong in its predictions, the internal variables involved in the erroneous result may be altered. By strategically altering the internal variables responsive to correct or incorrect predictions, the internal variables may be successively refined until the ability of the AI model to analyze play action and predict the outcome will improve. Thus in this embodiment, the job of the expert is to rate the AI model's performance, so that the AI model can subsequently provide better situational analysis, better outcome predictions, and better evaluations of player performance.

By either the first or second method, the AI model may be sufficiently trained to predict the outcomes of realistic play scenarios, based on the performance of a particular player (usually the quarterback). The AI model is then applied to a draft candidate's video record from previous games, and/or to compare the predicted performance metrics of two or several of the draft candidates. With such an analytical advantage, the teams that use the disclosed AI-assisted selection process may obtain improved draft strategies, resulting in better season outcomes, than when relying on human intuition. When properly trained, a good AI model can do so better, in many cases, than any human.

In a first aspect, there is a method for selecting a candidate for a quarterback position of American-style football, the method comprising: determining, according to at least one frame of a video record of the candidate during a football game, one or more athletic performance parameters of the candidate, according to actions of the candidate depicted in the at least one frame; determining one or more physical metrics comprising a dimension or a strength or a speed of the candidate; determining one or more skill metrics comprising an agility or a throwing accuracy of the candidate; determining one or more mental metrics comprising an adversity tolerance or a situational awareness of the candidate; providing the one or more athletic performance parameters, the one or more physical metrics, the one or more skill metrics, and the one or more mental metrics, as inputs to an Artificial Intelligence (AI) model; and determining, as output from the AI model, a predicted athletic performance of the candidate in the quarterback position of American-style football.

In another aspect, there is a method for training an Artificial Intelligence (AI) model, the method comprising: using an AI model comprising software configured to determine one or more outputs operably connected by links to one or more inputs or to one or more internal functions, the internal functions comprising adjustable variables; determining data about each prior player of a plurality of prior players, each prior player comprising an athlete; determining a history of athletic performance of each prior player of the plurality, the history of athletic performance comprising data about the prior player playing American-style football; for each prior player of the plurality: determining, according to at least one frame of a video record of the prior player playing American-style football, at least one athletic performance parameter; providing, as input to the AI model, the at least one athletic performance parameter and the data about the prior player; determining a predicted athletic performance of the prior player according to output of the AI model; adjusting one or more of the adjustable variables; repeating the above two steps until a predetermined level of agreement is obtained between the predicted athletic performance the prior player and the history of athletic performance of the prior player; and providing the AI model to a user, configured to predict a predicted athletic performance of a draft candidate for American-style football.

In another aspect, there is a method for selecting a particular candidate for a position of quarterback in American-style football, selected from a plurality of candidates, the method comprising: using an Artificial Intelligence (AI) model trained to predict a future athletic performance of a particular candidate of the plurality, according to input data about the particular candidate; recording a video record of the particular candidate playing a football game in the quarterback position; providing, as input to the AI model, the video record or selected frames of the video record; determining, as output from the AI model, a prediction of a success or failure of a particular play action of the particular candidate, the particular play action depicted in particular frames of the video record; comparing the predicted success or failure to a subsequent outcome, the subsequent outcome comprising a success or a failure of the particular play action as indicated in subsequent frames of the video record; and adjusting one or more variables of the AI model to improve the prediction.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### BRIEF DESCRIPTION OF THE DRAWINGS

FIG. 1 is a photograph in which the circled area depicts the area of interest.

FIG. 2 is a photograph showing an area of interest other than the quarterback position.

FIG. 3 is a photograph showing that multiple areas of interest can be AI-modelled simultaneously.

FIG. 4 shows the trajectory or a perfect touchdown pass (‘bomb’).

FIG. 5 shows the receiver catching this absolutely perfect touchdown pass.

FIG. 6 is a schematic showing an exemplary embodiment of an AI structure embodied as a neural net, according to some embodiments.

FIG. 7A-7D are charts showing exemplary embodiments of input data for an AI model, according to some embodiments.

FIG. 7E is a chart showing an exemplary embodiment of output data from an AI model, according to some embodiments.

FIG. 8 is a flowchart showing an exemplary embodiment of a process for training an AI model, according to some embodiments.

FIG. 9 is a flowchart showing an exemplary embodiment of a process for using an AI model, according to some embodiments.

FIG. 10 is a chart showing an exemplary embodiment of the career success trajectory of athletes, according to some embodiments.

Like reference numerals refer to like elements throughout.

### DETAILED DESCRIPTION

Systems and methods disclosed herein (the “systems” and “methods”, also occasionally termed “embodiments” or “arrangements” or “versions” or “examples”, generally according to present principles) can provide urgently needed systems and methods for rationally selecting draft candidates for professional American-style football, as currently practiced in the NFL National Football League in the United States. Substantial sums of money are involved in such decisions, especially considering the effect of an excellent choice on a team's long-term winning prospects. As with any competitive sport, fans flock to teams that win; hence owners are under enormous pressure to select draft candidates with the greatest promise. However, the selection remains an obscure art with mixed results in the best cases.

Trained Artificial Intelligence model for analyses, correlations, and cross-correlations for football players—both at the college level and at the NFL level. ALL the metrics in the present disclosure related to the quarterback position—or, for that matter, to any other football position of interest to NFL coaches, scouts, and owners—can be Artificial Intelligence comparisons between the metrics of potential draft-worthy college quarterbacks to the outstanding quarterbacks in the National Football League.

With training of the AI model of the present disclosure relative importance values can be made for these NFL vs. college metrics, as some metrics are more important than others. Such value determinations can be effectively made by the trained Artificial Intelligence model of the present disclosure employing freeze-frame video data acquisition—as well as utilizing AI-modelled relative valuations of physical, mental, situational awareness (SA), emotional, and background metrics.

And within the National Football League, quarterbacks sometimes change teams, voluntarily as free agents, or in a trade between NFL teams. The metrics of all starting NFL quarterbacks in the 32 teams, and even promising NFL backup quarterbacks who are considered ultimately for the starting role, can be compared utilizing the Artificial Intelligence trained model of the present disclosure. It is a superior plan to do anything and everything possible to climb to the top of the very highest mountain and—WIN!

Returning to the unparalleled and immensely quotable Green Bay Packers' Head Coach, Vince Lombardi—who believed with all his heart and soul that winning is more important than anything else in life: “Defeat is worse than death—because you have to live with defeat.”

Accordingly, an improved training procedure for AI models is disclosed herein, based on AI analysis of data on each candidate, based in part on freeze-frame video data of prior games involving draft candidates. The disclosed procedure(s) is/are expected to provide substantially improved selections, resulting in long-term competitive advantages to teams and to the sport in general, according to some embodiments. Most of the examples pertain to selection of a quarterback in American-style football, especially at the level of the National Football League, but the same or similar procedures are expected to enable enhanced selection success for other professional football positions as well, and for other competitive sports, and for other situations requiring superior personal performance under duress (such as the military).

Note: This disclosure is directed not only to the foremost and most renowned American football league—namely, the National Football League (or subsequent name if a name change occurs)—but is also certainly applicable to any league or team playing professional American football, be it in the United States or elsewhere.

Disclosed below are some of the multitudinous variables (‘metrics’) which are highly amenable to the application of Artificial Intelligence analyses to greatly improve the accuracy of determining the athletic ability of a potential NFL player to succeed at the next level up from his collegiate career.

As quarterback is the most difficult position in the NFL to determine with any precision the ultimate ‘winability’ of an athletic prospect—we will use the quarterback position for illustrative purposes—keeping in mind that many of the metrics, such as those below—and others—can certainly be applied to other NFL football positions—to enhance significantly the possibility of a successful selection of a winning NFL athlete.

In examples below, the AI model can take, as input, measurements and facts related to athletic prowess, categorized here into various performance indicators critical for rating or comparing the draft candidates. The AI inputs may be categorized as physical metrics (such as strength), skill metrics (such as passing ability), mental metrics (such as persistence despite setbacks), personal metrics (such as achievements and awards), and institutional metrics (such as high school or college data). A final category, historical metrics, provides a “ground truth” of prior in-game performance data. The historical metrics can be used for training the AI model or to refine the adjustable variables in the AI model to improve accuracy, as in “supervised learning”.

AI can provide insightful predictions, based only on input data, when trained with a sufficient number of prior examples. Crucially, the training data must include the metrics and subsequent performance data on the prior players that failed in professional football (despite promising stats in high school and college football) as well as those who succeeded. By exploiting subtle cross-correlations that differ between the successful and unsuccessful players, AI can provide substantially improved predictive accuracy. AI is uniquely suited to this type of nonlinear and highly cross-correlated problem.

After proper training. AI performance often exceeds the intellectual capabilities of even the most talented humans. The reasons for this phenomenal success rate are (a) AI models can account for larger numbers of variables than any human, and (b) AI can reveal subtle correlations between the input data and the output predictions, correlations that are scarcely visible to human experts. But most importantly, AI can detect even more subtle cross-correlations among multiple input factors, such as cross-correlations in which one factor has an unexpected confounding effect on other factors, and vice-versa. When the problem involves a large number of input factors interacting in complex ways, it is unlikely that such cross-correlations will ever be comprehended by any human. A well-trained AI model, on the other hand, easily uses such cross-correlations among the input data to generate superior predictive power.

The AI model is developed by adjusting the internal variables until the predicted performance of a particular player, based on his input metrics, is sufficiently in agreement with the observed subsequent performance in, for example, college games. The AI model is further developed by adjusting the variables to accommodate the measurements of a large number of players while predicting their performance with adequate accuracy. Usually a large computer, such as a supercomputer or a quantum computer, is required to process all of the data and all of the players in the large training set, finally arriving at settings of the variables that produce the desired predictions.

For example, regarding the quarterback performance prediction problem, the inputs are the metrics and the prior performance of each player, while the training goal is the subsequent degree of success of that player in professional football. History has shown that humans cannot account for all the complex nonlinear correlations between the metrics and the subsequent performance, and indeed are hopeless at discerning the important cross-correlations that largely determine success or failure when maximally challenged. Hence the need for a program that can—an AI model.

In some embodiments, the adjusting of the variables may be performed automatically, such as by a computer. In some embodiments, the variables of the AI model (the “development” model) may be adjusted by another AI model (the “adjuster” model) which has been trained to recognize advantageous adjustment trajectories in complex interconnected data, such as the performance data. The adjuster model may then take over the training process by determining an optimal route, or at least an improved route, for making changes in the development model. In particular, the adjuster model may be able to recognize complex correlations among a large number of inter-related parameters, complex correlations that a human could not possibly comprehend but that enable an economical approach to a successful development model. Absent the AI adjuster model, the supercomputer would have to make a very large number of semi-random iterative adjustment steps before a suitable solution can be reached, if at all. Thus, the AI adjuster model may enhance the optimization of the development model in the same way that the development model, when finished, can enhance the selection of an optimal draft pick.

After being trained, the AI model may be passed to a user for evaluating draft candidates. However, the full development codes may be unwieldy due to the large size and complexity of typical AI models when in development. Alternatively, the AI model may be prepared for use on ordinary computers, by freezing the variables at their optimal settings, identifying and removing inputs that have little or no effect on the predictions, removing internal functions that have little or no effect on the predictions, and otherwise simplifying the prediction-generating code. As a further alternative, the distribution code provided to the end user may be an algorithm or software package or table or matrix or graphical process or weighted sum formula, or other calculation means derived from the AI model, but easier for an ordinary computer to use.

As a further advantageous enhancement, the AI model, or another algorithm that uses the same input data, may determine an uncertainty in each prediction. The uncertainty may be based on the accumulated uncertainties in the input data. The output uncertainty may further account for how “firm” the prediction is (that is, how far the prediction could be altered without significantly reducing its likelihood). When certain pieces of data are unavailable for a particular player, that lack may also be included in the uncertainty calculation. The user may then regard the uncertainty in a prediction as well as the prediction result, and the uncertainty may greatly affect whether the user will decide to act upon the prediction.

In some cases, the AI model may provide, as further output, a comparison or ranking of each candidate for a particular position, or for all of the positions in the sport, based on the input data of each candidate. The user can then review the rankings in determining a selection strategy, based on which positions need to be filled, available funds, and other realities which are outside the domain of the AI model.

In some cases, the user may wish to adapt the AI model to the user's own priorities or knowledge by adjusting the internal variables of the model in the field. However, adjusting the variables at random would likely spoil the predictive accuracy promptly. Therefore, the supercomputer that developed the AI model may further provide a table of function (the “adjustment matrix”) indicating how the internal variables can be adjusted to obtain a specific result. For example, if the user wishes to emphasize the rushing game instead of the passing game, then the predicted performance of the quarterback candidates would likely be changed. The development computer can thereby assist the user, by determining which variables should be altered, and how much, in order to optimize the predictions for the rushing game, or other customized goals that users may desire.

As used herein, “draft” refers to a process of allocating novice players to various teams, wherein the lowest-scoring team gets first pick of the available candidates. Artificial Intelligence (AI) refers to computer-based decision-making according to a multitude of previous examples. An AI “structure” is software configured with numerous internal variables that, when provided with input data, generate an output. The AI structure is “trained” by adjusting the internal variables so that the output agrees with a “ground truth” associated with the input data, in a process termed “supervised machine learning”. (To avoid confusion, the term “training” is reserved herein for AI model development only, and will NOT be used to refer to athletic practicing or skill development.) After the internal variables are suitably trained, the AI structure has thereby graduated to an “AI model” since it is now capable of predicting the future athletic performance of the draft candidates. There is substantial value in determining the most promising candidate; hence the need for the disclosed procedures.

Turning now to the figures, the following examples show how an AI model may be structured, trained, and then used for selecting a draft candidate.

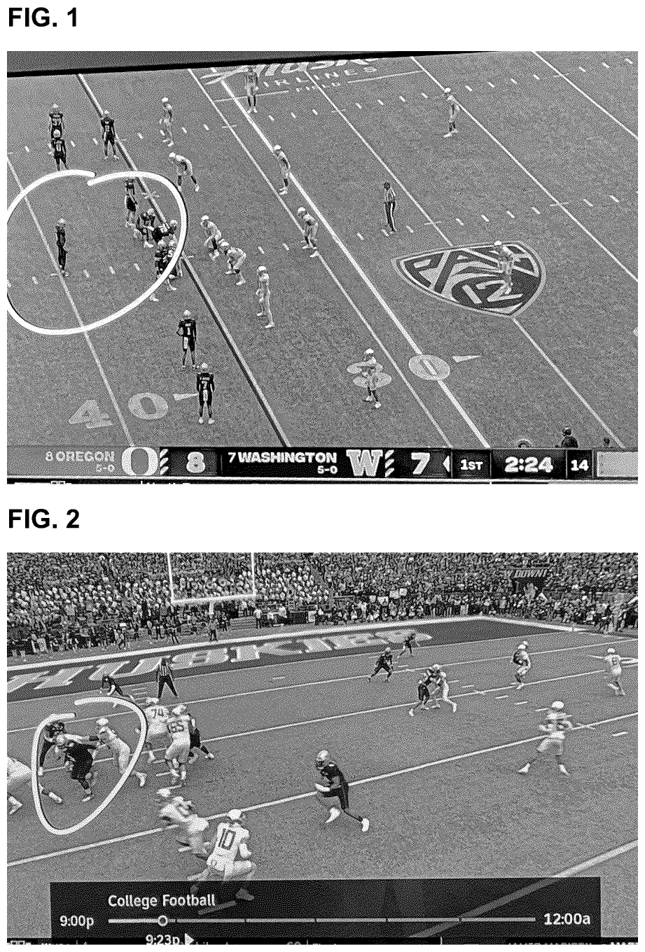

FIG. 1 is a photograph in which the circled area depicts the area of interest—in this instance, the quarterback in the ‘shotgun’ position a few steps in back of the center lineman, who ‘snaps’ the football back to the quarterback. As soon as the football is caught by the quarterback, freeze-frame video photography and a time clock can provide precise video documentation for how long the quarterback has the football in his hands.

With the relentless pass rush by NFL defenders salivating to get to the quarterback for a ‘sack,’ (tackling the quarterback to the ground), a successful quarterback who lives to see another day gets rid of the football as quickly as possible. This might be by handing it off to a running back, or by passing the football to a receiver.

The time allotted for the quarterback to make a hand off or passing decision is generally much less in the National Football League vs. the time allotted in college football. Therefore, the quicker the quarterback executes the decision to either hand off or execute a pass means that quarterback will endure less punishment at the hands of the defense, who are akin to very hungry lions.

And sometimes, a particularly enthusiastic (read ‘violent’) quarterback ‘sack’ by the defense can cause even a season-ending injury.

An example of a National Football League star quarterback who generally escaped a mauling by the very ‘hungry’ NFL defenses is Dan Marino of the Miami Dolphins. Why? He got rid of the football as fast as possible, thereby rendering himself safe from the typical mauling for holding onto the football too long before making a hand off/pass decision. Renowned for his ‘quick release,’ Marino had a long and fruitful NFL career, playing for 17 seasons and throwing 61,361 yards and 420 touchdowns for the Dolphins. Selected to play in 9 Pro Bowls, Dan Marino was honored to be elected to the NFL Hall of Fame.

Josh Allen, the star quarterback of the National Football League's Buffalo Bills, can readily complete a pass downfield with the actual time in his hands of only 2.75 seconds. This is astoundingly and almost inhumanly quick—not only to make the correct passing decision, but then to successfully execute a perfect pass—and this even if the intended receiver is very closely covered by the defending linebacker(s).

It cannot be over-emphasized herein that the time the football is in the quarterback's hands is an extremely important metric for the AI model of the present disclosure. College quarterbacks with NFL potential should be carefully analyzed utilizing the trained AI model described herein—and if the college quarterback under this trained AI microscope cannot rid himself of the football very quickly—meaning in essentially the same time frame as that afforded to winning National Football League quarterbacks—a dim view of this college quarterback's lack of a quick release would be taken by NFL teams. This college quarterback will have a very hard time winning NFL games, and ominously, could very well succumb to serious and even a career-ending injury at the hands of the ravenous NFL defensive squads.

Therefore, the vital metric of how long the college quarterback takes to make a definitive decision to hand off or pass the football—or even occasionally to run with the football, dangerous as it is to his physical well-being—should be compared using the AI-trained model of the present disclosure to that of winning National Football League quarterbacks.

Freeze-frame video technology can provide millisecond-by-millisecond data for the trained Artificial Intelligence model of the present disclosure for a plethora of other important metrics. After training, the AI model can then weigh these individual metrics, giving a value number, such as from 1-10, as some metrics are more vital to success in the National Football League than others. AI can determine which metrics are absolutely essential and which are of lesser importance.

AI analyses, correlations, and cross-correlations for college football players can be compared to National Football League players—particularly to the quarterback position. Although other metrics are applicable to the AI model of the present disclosure, as this list below is non-exclusive, certainly the following metrics can be AI analyzed, correlated, and cross-correlated.

Pass Accuracy. The hallmark of a National Football League quarterback is pass accuracy. Without this attribute, a quarterback cannot win the punishing world of the NFL. Pass accuracy is important not only for shorter more easy-to-complete passes, but is essential for longer passes, and even vital for very long passes (‘bombs’) when the outcome of the game is on the line. Winning a close game often depends on completing a long touchdown ‘bomb’ in the final seconds of the 4^{th} quarter—even when the intended receiver is ‘covered’ by more than one defender. Quarterbacks who win games continue in the NFL. Those who don't watch National Football Games on TV or buy a ticket.

The aforementioned Drew Brees of the New Orleans Saints (traded to the Saints by the then San Diego Chargers) is the most accurate NFL quarterback in history of quarterbacks throwing over 1,500 passes. His completion rate is 67.7 percent for passes 20+ yards, which places him at Number One for passes at this distance. Retiring in 2020 after twenty years in the National Football League, Brees's passing stats are 80,358 yards, and 571 touchdowns. Eligible for induction into the Pro Football Hall of Fame in Canton. Ohio in 2026. Drew Brees is widely expected to be selected on his first ballot. This is a truly exceptional NFL quarterback!

Other metrics of importance for the analyses, correlations, and cross-correlations for the quarterback position include, but are not limited to:

The obsessive drive to win EVERY GAME.

Ability to see the entire field.

Ability to ‘look off’ one potential receiver, and then pass to another receiver.

Pass distance.

Pass velocity.

Pass trajectory.

Distance between the intended receiver and the nearest defender, or defenders.

Number of defenders ‘covering’ the intended receiver.

Ability of the quarterback to pass on the run—to the left, and to the right.

Ability to run the ball, when required by circumstances (such as all receivers ‘covered’).

Talents of the intended receiver.

Talents of the pass defender.

Emotional pressure score.

Situational awareness (SA) score.

FIG. 2 is a photograph showing an area of interest other than the quarterback position. The trained AI-model of the present disclosure can simultaneously analyze, correlate, and cross-correlate data—on a frame-by-frame basis—the videographic activities of any and all players on either side of the football—both on offense and on defense. This videographic data is then appropriate per the present disclosure for making AI-trained comparisons, such as between college players at such-and-such a position; and certainly of great benefit to NFL coaches, owners, and scouts—between college players and those in similar football positions in the National Football League. Thus, to emphasize, the present disclosure is applicable for any selected football position—and especially for the enigmatic, mystifying position of quarterback. It is also ideally applicable within the National Football League for players changing teams, such as being traded or entering free agency.

Areas of interest for the present disclosure's trained AI analyzes, correlations, and cross-correlations for football positions other than quarterback include the intended receiver whose job is to make the catch—and the defender or defenders whose job is to prevent completion of the pass, or even to intercept the pass and cause a calamitous turnover for the offensive passing team.

The quality of the receiver and that of the pass defender(s) can make or break a pass play. There is no question that NFL quarterback Tom Brady's 7 Super Bowl wins are in part the benefit of truly phenomenal pass receivers—Julian Edelman, the MVP of the 2019 Super Bowl (#53—Roman numeral LIII), for instance. You can observe his truly stunning performance in this Super Bowl win for the New England Patriots as a benchmark of excellence at the position of wide receiver. And, of course, there is tight-end receiver 6′ 6″/265 pounds Rob Gronkowski (the ‘Gronk’), who will assuredly be elected to the NFL Pro Football Hall of Fame just as soon as he becomes eligible. The Brady-Gronkowski duo resulted in 105 NFL touchdown passes for win after win/after win for the New England Patriots and the Tampa Bay Buccaneers.

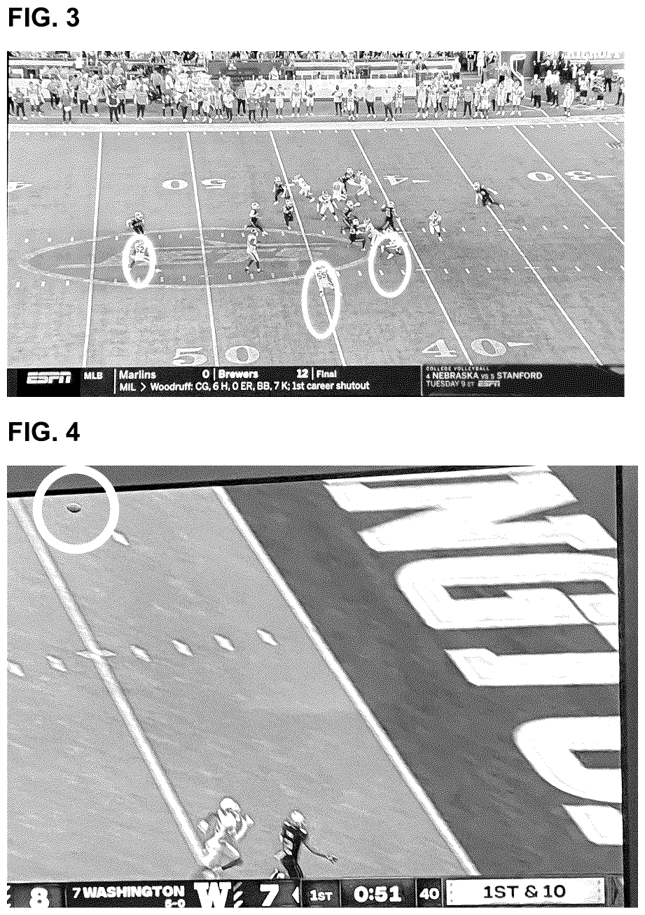

FIG. 3 is a photograph showing that multiple areas of interest can be modelled at precisely the same time, as the present disclosure's freeze-frame AI-trained model can ‘watch’ multiple players on each play. For instance, 6 potential receivers on offense are eligible to receive a pass. Therefore, the pass routes of all 6 receivers can be frame-by-frame modelled simultaneously. Then, a determination according to the present disclosure's trained AI model can be made whether (or not) the quarterback made the best passing decision. Was the intended pass aimed at the receiver who was most ‘open’ for receiving the pass? Making these simultaneous analyses is a measure of the quarterback's ability to see the entire field—and then to make a correct split-second decision to pass to the most open receiver.

Current quarterbacks in the National Football League with this phenomenal instinctive ability include—among other top-tier NFL quarterbacks—Lamar Jackson of the Baltimore Ravens, Patrick Mahomes of the Kansas City Chiefs, Joe Burrow on the Cincinnati Bengals, Josh Allen of the Buffalo Bills, Jalen Hurts of the Philadelphia Eagles, Dak Prescott of the Dallas Cowboys, Jared Goff of the Detroit Lions, Matthew Stafford of the Los Angeles Rams, and when he recovers from his Achilles tear injury, Aaron Rodgers now of the New York Jets. And in his brief career thus far, Brock Purdy of the San Francisco 49ers. These gifted quarterbacks can perform at this supremely regal level even in the face of a lion-like defensive pass rush.

FIG. 4 shows the trajectory or a perfect touchdown pass (‘bomb’). This pass is thrown by the University of Washington's remarkably talented senior starting quarterback Michael Penix Jr.—a serious candidate for the 2023 Heisman Award. The football (circled) is at the top of screen.

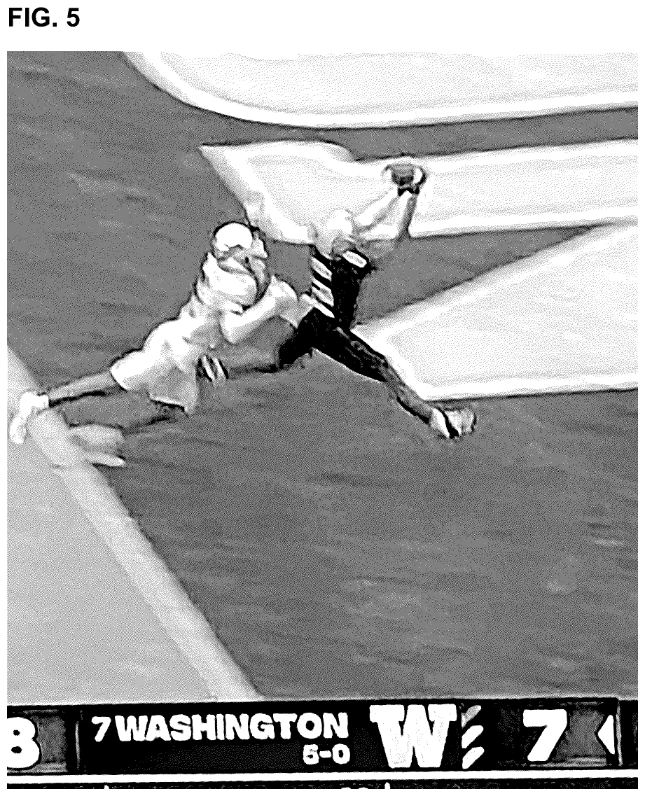

FIG. 5 shows the receiver catching this absolutely perfect touchdown pass. This is a perfect pass for a touchdown for the reason that the defending free safety cannot bat the football to the ground for an incomplete pass, or intercept it for a turnover. Note how closely covered the receiver is by the pass defender, who is doing as fine a job as can be humanly done to prevent the touchdown pass. And even with the defender's arms over his head in a futile effort to block the pass, the pass would still be complete for a beautiful touchdown, again because of its perfect trajectory over the pass defender, perfect velocity, and perfect distance. Also note that the pass is caught by the receiver's outstretched arms on the full run without breaking stride. This pass cannot be defended against once it is in the air and the receiver is in position to make the catch. It is a perfect pass!

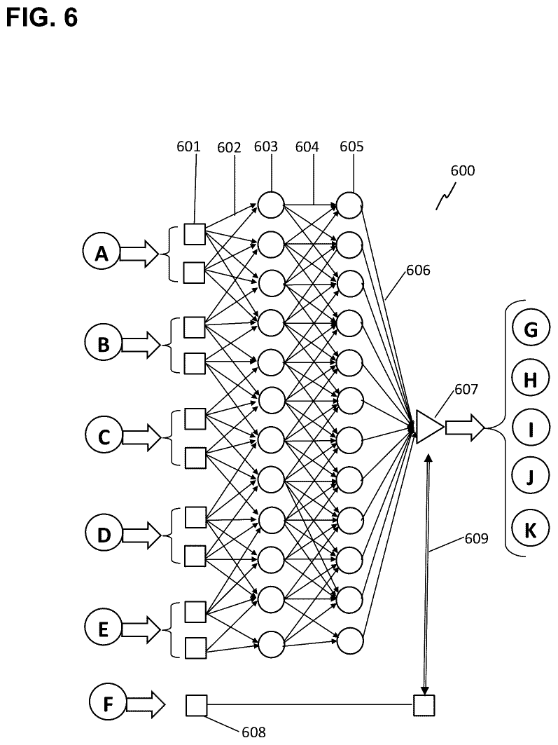

FIG. 6 is a schematic showing an exemplary embodiment of a neural net Artificial Intelligence model, according to some embodiments. As depicted in this non-limiting example, an AI structure 600, depicted here as a neural net, has a number of inputs 601, one or more intermediate layers of internal functions 603, 605 and one or more outputs 607. The internal functions 603, 605 are operationally connected to the inputs 601 and each other by links 602, 604, while the output 607 is connected to the last layer of the internal functions 605 by further links 606. Although links are shown connecting only a few of the internal functions, in many AI structures each input and each internal function is linked to all of the internal functions of the succeeding layer. All of the links are unidirectional in this case; other embodiments include links going backwards and other complex topologies, although doing so can inhibit convergence.

The AI structure 600 is turned into an AI “model” by adjusting numerous adjustable variables in the internal functions 603, 605. In some embodiments, the links 602, 604, 606 can also include adjustable variables, while other links are simple transfer links. The internal functions can include any type of calculation or logic relating the internal function's input link values to its output link values. In some embodiments, all of the output link values of a particular internal function are identical, while in other embodiments each link can have a different value and a different relation to that internal function's input link values.

The AI model can generate phenomenal predictions by combining the input values using the adjustable weighting factors (among other factors such as thresholds and compression parameters) that determine how each input value interacts with each other input value. The AI model is then trained using prior example data, by adjusting the weighting factors until the predictions match the actual performance of the prior players.

During model development, the inputs 601 generally include a large number of players of various levels, and the ground truth 608 would include the subsequent performance level of those players in, for example, college or professional football. As mentioned, the metrics and subsequent performance data of both NFL-winning and unsuccessful players are preferably included in the training set, so that the AI model can discern subtle cross-correlations among the input data that relate to the ultimate success or failure of each candidate. After each prediction, the output 607 is compared 609 to the actual performance 608 of the player in subsequent games, and unless the prediction is accurate, the internal variables are adjusted again. This cycle is repeated many times with as many players as can be provided with past data and performance, in order to refine the model and improve the prediction accuracy. After the AI model has reached a satisfactory level of predictive accuracy for a sufficient range of players, the model is then rendered suitable for an ordinary computer, as mentioned, and made available to a user. The user than inputs the data about one or a number of draft candidates and determines as output the predicted performance of those candidates. The output 607 may be a prediction of the future athletic performance of each draft candidate separately, or a list or table ranking or comparing a number of draft candidates, depending on user needs. The outputs 607 may further include an uncertainty in the prediction, as mentioned.

By adjusting the weights and combinations according to the prior player data, the AI model can uncover complex cross-correlations involving multiple input factors in complex and unexpected ways. For example, a neural net with ten internal layers can account for cross-correlations involving any ten of the input values in any combination, while a model with 100 layers can discern subtle cross-correlation effects among any 100 of the input values.

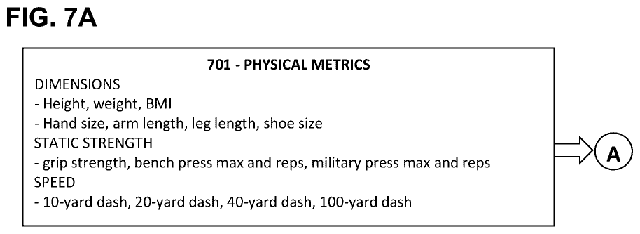

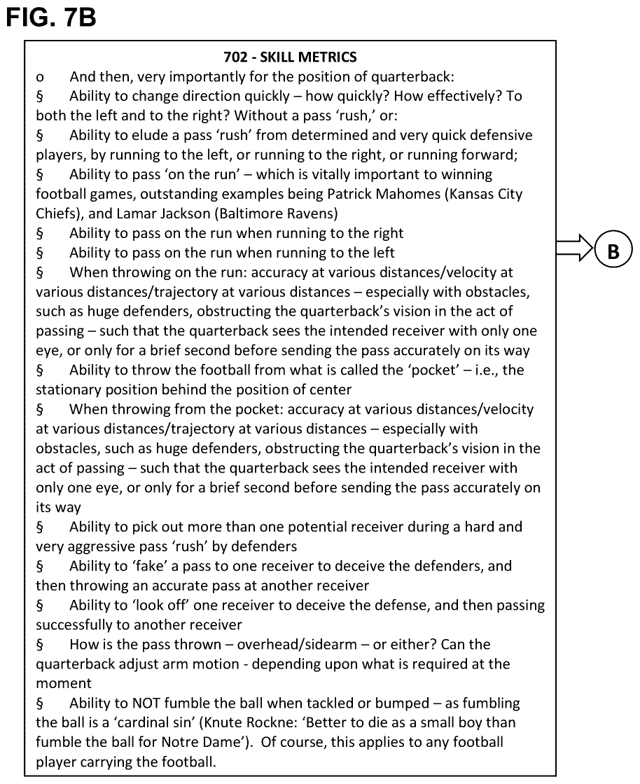

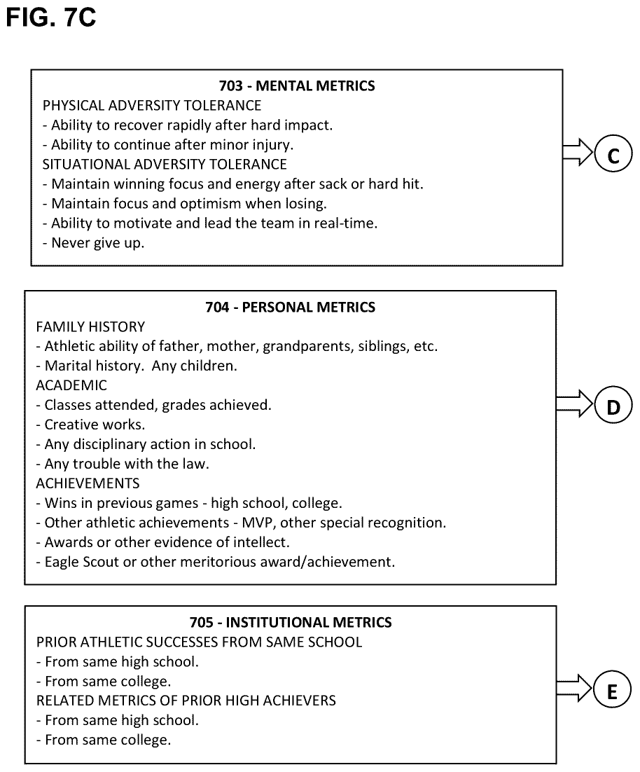

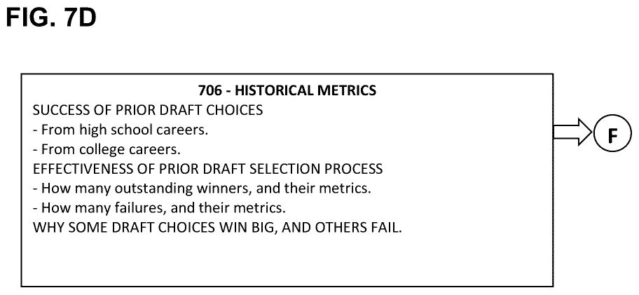

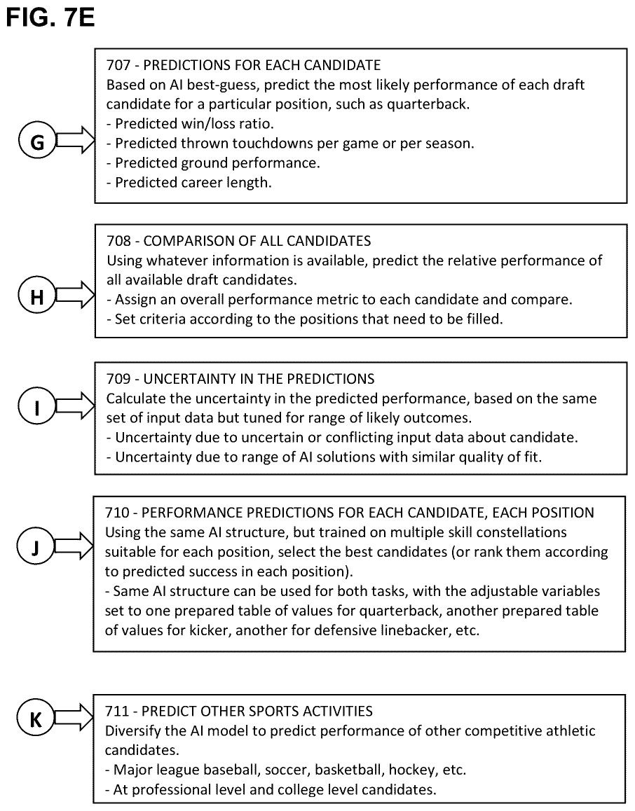

FIG. 7A is a chart showing an exemplary embodiment of input data for an AI model, according to some embodiments. As depicted in this non-limiting example, the inputs may include physical metrics 701 which correspond to item “A” in FIG. 6. The physical metrics 701 may include dimensional data such as the height and weight of a draft candidate, static strength measurements such as the grip strength, and speed measurements such as the ten-yard dash.

FIG. 7B is a chart showing an exemplary embodiment of input data for an AI model, according to some embodiments. As depicted in this non-limiting example, the inputs may further include skill metrics 702, corresponding to item “B” in FIG. 6. The skill metrics 702 may include agility such as the ability to change direction quickly and the ability to pass while in motion, throwing metrics such as accuracy versus distance, versatility such as the ability to throw from all field positions, various passing types such as the ability to fake a pass, and fault avoidance such as the ability to take a hit without dropping the ball.

FIG. 7C is a chart showing an exemplary embodiment of input data for an AI model, according to some embodiments. As depicted in this non-limiting example, the inputs may further include mental metrics 703 corresponding to item “C” in FIG. 6. The mental metrics 703 may include the attitude and self-control required to recover rapidly after a sack, and the self-confidence to maintain a winning focus even when others would give up. These are the critical advantages that make a winning player.

The inputs may include personal metrics 704, corresponding to item “D” in FIG. 6. The personal metrics 704 may include the family history from an athletic perspective, academic history including any disciplinary actions, and special achievements or awards, and especially the candidate's personal history of game wins and other athletic accomplishments such as Most Valuable Player (MVP) awards and the like.

The inputs may further include institutional metrics 705, corresponding to item “E” in FIG. 6. The institutional metrics 705 may include other players from the same school that went on to achieve great success, as well as the other metrics (physical, skill, etc.) of other players from the same institutions. This accounts for the extraordinary effectiveness of experience at certain institutions.

FIG. 7D is a chart showing an exemplary embodiment of input data for an AI model, according to some embodiments. As depicted in this non-limiting example, the inputs may further include historical metrics 706, corresponding to item “F” in FIG. 6. Unlike the other metrics, the historical metrics 706 are not used as inputs to the AI model directly, but rather as “ground truth” for testing the accuracy of the predictions. The historical metrics 706 may include the success, or otherwise, of prior draft candidates, the effectiveness of prior draft selection processes (with or without AI assistance), and the most difficult question of all: why some candidates win big while others fail. During training of the AI model, the historical metrics 706 are used for supervised training, or to guide the adjustment of the internal variables for increased predictive accuracy.

FIG. 7E is a chart showing an exemplary embodiment of output data from an AI model, according to some embodiments. As depicted in this non-limiting example, the outputs may include predictions for each candidate 707, corresponding to item “G” in FIG. 6. The predictions for each candidate may include the win/loss ratio or the number of thrown touchdowns per game, according to the AI model outputs.

The outputs may further include a comparison 708 of all (or a selected subset) or the candidates. The candidate comparison 708 may include an overall performance metric for each candidate, or a ranking of each candidate regardless of the actual predicted performance, or other comparative analysis of the choices. In practice, the ranking criteria preferably account for the positions that the team needs to fill.

The outputs may further include an uncertainty 709 in the predictions or rankings, corresponding to item “I” in FIG. 6. The uncertainty 709 may be calculated according to uncertainty estimates of the input data, and/or which input data values are unknown or missing, and/or a determination of the range of predictions that have about the same likelihood according to the AI model. If a wide range of different predicted performance levels all have about the same likelihood, as determined by the AI model, then the uncertainty assigned to the prediction must be made at least that wide. In contrast, a prediction with low uncertainty has a rapid decline in likelihood if the prediction value is altered significantly.

The outputs may further include a matrix-like presentation 710 such as an evaluation of the performance of each draft candidate in each position, corresponding to item “J” in FIG. 6. A good player can generally perform well in more than one position. A good player will invoke alternate skill sets when needed, such as when conditions suddenly change (as when a fumble is recovered by the other team, and offense suddenly has to play defense).

The outputs may further include performance predictions of candidates in other sports activities 711, other than American-style football, corresponding to item “K” in FIG. 6. The predictions for other sports activities 711 may include candidates for positions in major-league baseball, soccer, basketball, hockey, and many other competitive athletic positions. Alternatively, the job may be something demanding premium physical performance other than professional sports, such as military or construction or lumberjack positions for example. The AI model, readjusted to account for the strength and skill levels required for the particular occupation, can then be used to select promising candidates in the same way as for professional sports teams. In general, the promise of AI is enhanced decision-making when a multitude of complex, interacting factors are operational.

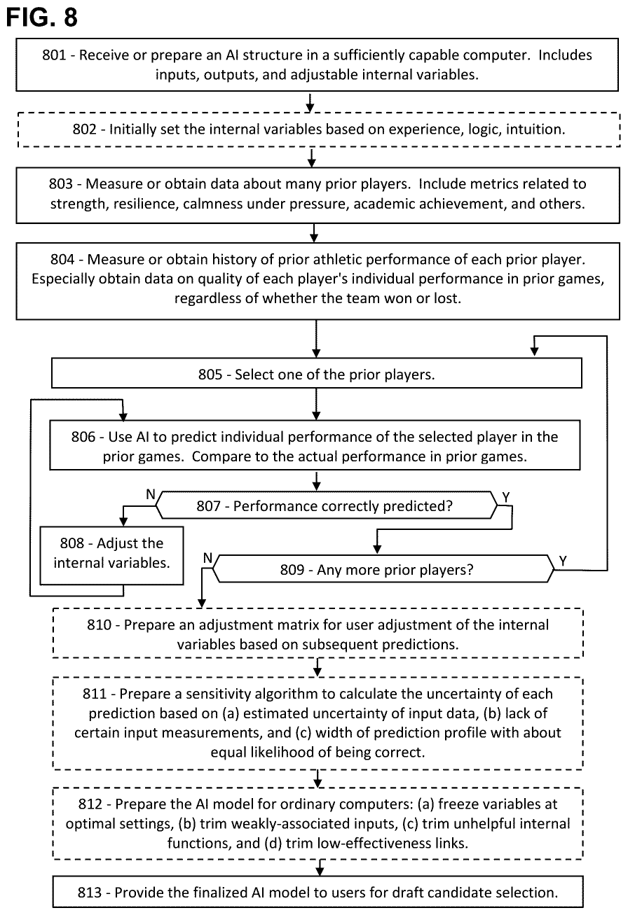

FIG. 8 is a flowchart showing an exemplary embodiment of a process for training an AI model, according to some embodiments. As depicted in this non-limiting example, an AI model for evaluating or predicting athletic performance of players is trained using historical records and past metric data. At 801, an entity can receive and AI structure, or prepare one anew. The AI structure is a computer program generally including inputs, internal variables and functions, and outputs dependent on the internal variables and functions. At 802, the internal variables are set at initial values based on, for example, experience or logic or intuition. Starting with a reasonable set of internal values greatly assists the training and convergence upon a suitable solution capable of accurate predictions.

At 803, input data about a large number of past players is obtained. The data may include the metrics listed an previous figures, or other data related to player performance. At 804, the historical performance of those past players is obtained, such as the number of games won or the player's individual level of performance in games. This historical data is not used as a direct input to the AI model, but rather as a ground truth for training and adjusting the internal variables.

At 805, one of the past players is selected, perhaps randomly or some other way, and at 806 the data on that player is fed into the AI as input. The AI then predicts the performance of the player. At 807, the prediction is compared to the historical performance of the player, and if the prediction is incorrect, at 808 the internal variables are adjusted in a way intended to bring the prediction more into alignment with the ground truth. The flow cycles back to 806 for another prediction, until adequate predictive accuracy is obtained. In early stages, a small improvement in predictive accuracy may be sufficient to satisfy this loop, whereas in later stages of fine-tuning, a much higher accuracy may be required as the AI model improves.

After a sufficiently accurate prediction is obtained, if there are additional past players in the training set at 809, the flow cycles back to 805 to refine the model using each of the past players in turn.

After all of the players have been used for input training, the list of past players may be used as input again, and the overall cycle may be repeated for all of the past players repeatedly, until the model is finally configured to provide adequate predictions for all of them, or until further improvement in prediction cannot be obtained. For clarity, this loop is not explicitly shown, but is to be understood from the 805 to 809 cycles.

As an alternative, the AI model can be trained using accumulated or averaged data, in which several of the past players with similar features and similar performance histories can be averaged together, thereby enabling that a general solution be reached faster than using the individual players separately. Many other strategies for training AI models using data agglomeration and iterative cycling are known and are included in the disclosure.

At 810, the finalized AI model may be used to develop an adjustment matrix, which indicates how the internal variables can be altered in order to obtain a desired change in the output predictions. For example, if a particular user is interested in using the model to select an outstanding defensive lineman rather than an offensive position, the adjustment matrix may indicate which of the internal variables to change, and in what direction, and how much. Since it is generally easier for the AI model developer to measure such cause-effect relationships, and to prepare the corresponding adjustment matrix for common types of user priorities, the adjustment matrix may be provided to the user along with the AI model itself, for field adjustment as needed.

At 811, the AI model, or another AI model, may be trained to calculate the uncertainty in the predictions. The uncertainty is valuable so that the user can determine whether to trust and act upon the prediction, or to disregard the prediction if the uncertainty is large. The uncertainty may be based on the uncertainties of the input values, if known or can be guessed. If some pieces of input data are missing or inconsistent with other pieces, the uncertainty in the prediction must be increased to reflect that lack. In addition, the AI model can determine a range of predictions that all have about the same likelihood, based on the inputs. If that range is quite narrow, then the uncertainty is low and the prediction may be considered precise. If that range is broad, then the prediction uncertainty is correspondingly large. Users may understand that it is risky to trust a software prediction at face value, without checking the uncertainty or despite a large reported uncertainty.

At 812, the AI model may be adapted for use by a user in an ordinary computer, instead of the supercomputer that the developer likely employed. Adapting the trained AI model for field use may include freezing the internal variables at their optimal values, based on the set of past players that the AI model was trained on; unimportant inputs may be eliminated (depending on the particular application/sport/position desired); unhelpful internal functions, having little or no effect on the output, may be eliminated; and links that are either redundant or irrelevant to the output can be trimmed, thereby providing a lighter, leaner software package that may be easier for users.

At 813, the finalized AI model, or the trimmed version, or an algorithm or software derived from it, is then provided to users for rationally selecting draft candidates for competitive sports.

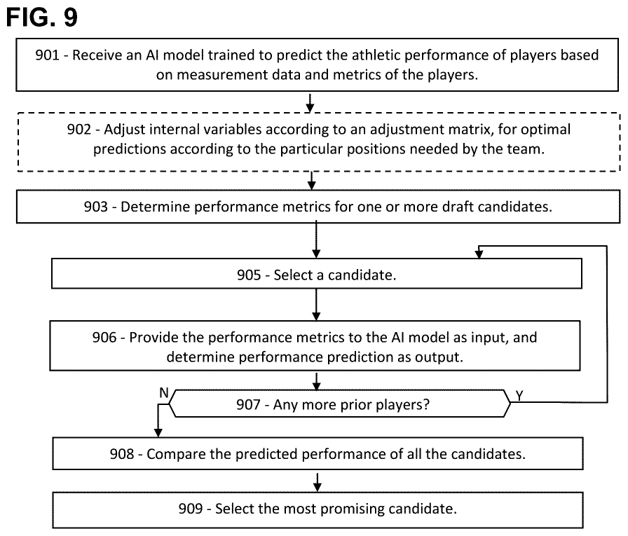

FIG. 9 is a flowchart showing an exemplary embodiment of a process for using an AI model, according to some embodiments. As depicted in this non-limiting example, at 901 a user receives an AI model trained to predict the athletic performance of a player based on the metrics data as described above. At 902, optionally, the user may adjust the internal variables of the AI model, using an adjustment matrix provided by the developer of the AI model, to optimize the predictions for the positions (or sports or weather conditions or other criterion) desired by the user.

At 903, the user determines or otherwise obtains the input data about the draft candidates, or at least a subset of the draft candidates that the user intends to consider. At 905, one candidate is selected and at 906, the input data on that candidate are provided to the AI model. The predicted performance of the candidate is then determined by the AI model. At 907, the user repeats the above cycle for all of the candidates of interest, and at 908 the user compares the predicted performance of the candidates, enabling the best choice to be made at 909.

Alternatively, not shown, the input data on all of the candidates may be provided to the AI model, and the AI model may be configured to rank the candidates or otherwise perform the comparison step based on the data.

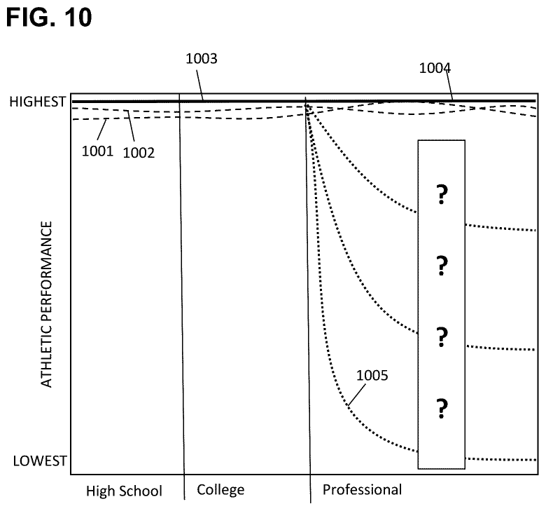

FIG. 10 is a chart showing an exemplary embodiment of a history of athletic performance, according to some embodiments. As depicted in this non-limiting, highly schematic representation, the athletic performance of players can be reliably predicted in some sports but not others, according to prior art. The athletic performance (such as win/loss ratio) of a player is shown on the vertical scale from lowest to highest performance levels, while the career stage (high school, college, professional) is shown horizontally. Dotted lines 1001, 1002 indicate the likely performance trajectory of top athletes in sports such as baseball 1001 and tennis 1002, as well as golf and many other sports. As depicted, an athlete who exhibits top performance in high school and college will usually continue to provide top performance as a professional.

In contrast, the quarterback position is much more difficult to predict, based solely on pre-professional scoring. The solid line 1003 shows an athlete exhibiting top performance as a quarterback in high school and college. In some cases 1004, the athlete continues to excel as a NFL professional as shown at 1004. In other cases 1005, the top performing quarterbacks in high school and college fail in the professional league. The historical record shows that it is difficult to discriminate between the quarterback candidates that continue to perform professionally 1004, and those who fail to perform 1005 in professional football, unlike the other sports.

Hence, the need for an improved means for determining which candidate has the best chance of prevailing as an NFL quarterback.

The following figures represent video freeze-frame images of a football game. A play has been captured on video and is being analyzed to provide training data to an AI model for evaluating the potential of certain players.

The play is recorded as it proceeds. Later, an expert can review the action frame-by-frame to evaluate which player performed well and which ones did badly. The quarterback is especially important in this play because he must time the pass exactly so that the ball will come down just in front of the receiver when he reaches the ball. Hence, the expert will pay close attention to how well the quarterback times the pass and regulates the direction and power of the pass so that the receiver can catch it.

In a first embodiment, the data accumulated in this process may be used as training input to an AI model, thereby providing granular detail as to which player performs at which level. In a second embodiment, the AI model has been successfully trained and now is being used to evaluate various draft candidates based on video coverage of past games. In either case, the huge amount of detail available from a frame-by-frame review of each play can provide superior predictive power, based on actual performance details as opposed to intuition, and thereby can enable better draft choices by revealing the most promising candidates.

AI models tend to be most adept at solving problems that are highly complex, with multiple interacting or correlated parameters and highly nonlinear effects. In the context of athletic performance prediction, AI may contribute beneficially in selecting which draft candidate best meets the needs of a particular team.

The AI model embodiments of this disclosure may be aptly suited for cloud backup protection, according to some embodiments. Furthermore, the cloud backup can be provided cyber-security, such as blockchain, to lock or protect data, thereby preventing malevolent actors from making changes.

In some embodiments, non-transitory computer-readable media may include instructions that, when executed by a computing environment, cause a method to be performed, the method according to the principles disclosed herein. In some embodiments, the instructions (such as software or firmware) may be upgradable or updatable, to provide additional capabilities and/or to fix errors and/or to remove security vulnerabilities, among many other reasons for updating software. In some embodiments, the updates may be provided monthly, quarterly, annually, every 2 or 3 or 4 years, or upon other interval, or at the convenience of the owner, for example. In some embodiments, the updates (especially updates providing added capabilities) may be provided on a fee basis. The intent of the updates may be to cause the updated software to perform better than previously, and to thereby provide additional user satisfaction.

The systems and methods may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, or sooner, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the robot, an inserted memory chip, hard drive, flash drives, flash memory, optical media, magnetic media, or any other type of file-storing medium. The outputs may be delivered to a user by way of signals transmitted to robot steering and throttle controls, a video graphics card or integrated graphics chipset coupled to a display that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi-connected device downloads a copy of the application to their device from a server using a wireless Internet connection. An appropriate authentication procedure and secure transaction process may provide for payment to be made to the seller. The application may download over the mobile connection, or over the Wi-Fi or other wireless network connection. The application may then be run by the user. Such a networked system may provide a suitable computing environment for an implementation in which a plurality of users provide separate inputs to the system and method.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”. “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

The present disclosure, employing extremely sensitive Artificial Intelligence modalities to analyze the gigantic number of physical, mental, and other intangible metrics—as well as analyzing all available background information—provides a superior methodology to answer this all-important question: Which athlete will most likely succeed in the National Football League, and which athlete most likely will not.

The Artificial Intelligence modalities described in the present disclosure, and those of the related United States patent applications of the co-inventors, comprise detailed analyses—and an infinite-number of possible cross-correlations—applied to a gigantic plethora of physical, background, mental, and intangible metrics. It should be emphasized that these AI cross-correlations are in such abundant numbers that their duplication is completely beyond human abilities.

The present disclosure demonstrates how Artificial Intelligence (AI) can analyze in huge detail the gigantic number of physical, mental, and other intangible metrics—as well as analyzing all available background information—to determine which athlete is most likely to succeed as a National Football League quarterback. Freeze-frame videographic data—as well as other critically important data on each quarterback candidate's strength, agility, speed, mental focus, and especially the innate talent to make the correct spontaneous winning decision, can be provided as input to the AI model—which then produces a prediction of the quarterback candidate's probability of success at the highest levels, and especially on the fiercely-grueling and merciless playing field of the National Football League. In the NFL, failure and defeat are NOT options. Additionally, the AI model can output a ranking of all the potential candidates at all other football positions. A well-trained AI model uses analyses, correlations, and cross-correlations scarcely visible to human experts among the input data to generate superior predictive power.

1. A method for selecting a candidate for a quarterback position of American-style football, the method comprising:
a) determining, according to at least one frame of a video record of the candidate during a football game, one or more athletic performance parameters of the candidate, according to actions of the candidate depicted in the at least one frame;
b) determining one or more physical metrics comprising a dimension or a strength or a speed of the candidate;
c) determining one or more skill metrics comprising an agility or a throwing accuracy of the candidate;
d) determining one or more mental metrics comprising an adversity tolerance or a situational awareness of the candidate;
e) providing the one or more athletic performance parameters, the one or more physical metrics, the one or more skill metrics, and the one or more mental metrics, as inputs to an Artificial Intelligence (AI) model; and
f) determining, as output from the AI model, a predicted athletic performance of the candidate in the quarterback position of American-style football.

2. The method of claim 1, wherein the one or more athletic performance parameters comprise an average release time of the candidate, wherein a release time equals a time interval between the candidate receiving a football and releasing the football, and the average release time comprises an average of two or more release times of the candidate, according to frames of the video record.

3. The method of claim 1, wherein the one or more athletic performance parameters comprise an average quarterback margin comprising a distance from the candidate to a closest defender when the candidate releases a football, and the average quarterback margin comprises an average of two or more quarterback margins, according to frames of the video record.

4. The method of claim 1, wherein the one or more athletic performance parameters comprise an average receiver margin, wherein the receiver margin comprises a distance from a receiver to a closest defender when the receiver catches a football, and wherein the average receiver margin comprises an average of two or more receiver margins, according to frames of the video record.

5. The method of claim 1, wherein the one or more athletic performance parameters comprise an average reception angle, wherein a reception angle comprises an angle of a trajectory of a football at a time when the a receiver catches, or attempts to catch, the football, and wherein the average reception angle comprises an average of two or more reception angles.

6. The method of claim 1, wherein the one or more athletic performance parameters comprise an average passing distance, wherein a passing distance comprises a distance between the candidate, at a time when a football is thrown by the candidate, and a receiver, at a time when the football is caught by the receiver, and wherein the average passing distance comprises an average of two or more passing distances.

7. The method of claim 1, wherein the one or more athletic performance parameters comprise an average pass speed, wherein a pass speed comprises a speed of a football when thrown, and wherein the average pass speed comprises an average of two or more pass speeds.

8. The method of claim 1, wherein the one or more athletic performance parameters comprise an average pass accuracy, wherein a pass accuracy comprises a distance between a an intended position of a football and an actual position of the football, at a time when a receiver catches, or attempts to catch, the football, and wherein the average pass accuracy comprises an average of two or more pass accuracies.

9. The method of claim 1, wherein the one or more athletic performance parameters comprise an average running speed of the candidate when throwing a football, wherein a running speed comprises a speed of the candidate at a time when the football is released by the candidate, and wherein the average running speed comprises an average of two or more running speeds.

10. The method of claim 1, wherein the one or more athletic performance parameters comprise an average emotional pressure score of the candidate, wherein an estimated emotional pressure score comprises an estimate of an amount of pressure exerted on the candidate by defending players, and wherein the average emotional pressure score comprises an average of two or more estimated emotional pressure scores.

11. The method of claim 1, wherein the one or more athletic performance parameters comprise an average situational awareness score of the candidate, wherein an estimated situational awareness comprises an estimate of the candidate's ability to locate an optimal receiver, and wherein the average situational awareness score comprises an average of two or more estimated situational awareness scores.

12. A method for training an Artificial Intelligence (AI) model, the method comprising:
a) using an AI model comprising software configured to determine one or more outputs operably connected by links to one or more inputs or to one or more internal functions, the internal functions comprising adjustable variables;
b) determining data about each prior player of a plurality of prior players, each prior player comprising an athlete;
c) determining a history of athletic performance of each prior player of the plurality, the history of athletic performance comprising data about the prior player playing American-style football;
d) for each prior player of the plurality:
i) determining, according to at least one frame of a video record of the prior player playing American-style football, at least one athletic performance parameter;
ii) providing, as input to the AI model, the at least one athletic performance parameter and the data about the prior player;
iii) determining a predicted athletic performance of the prior player according to output of the AI model;
iv) adjusting one or more of the adjustable variables;
v) repeating the above two steps until a predetermined level of agreement is obtained between the predicted athletic performance the prior player and the history of athletic performance of the prior player; and
e) providing the AI model to a user, configured to predict a predicted athletic performance of a draft candidate for American-style football.

13. The method of claim 12, wherein the at least one athletic performance parameter of each prior player, according to at least one frame of the video record, comprises a time between the prior player receiving a football and releasing the football.

14. The method of claim 12, wherein the at least one athletic performance parameter of each prior player, according to at least one frame of the video record, comprises a distance between the prior player and a closest defensive player at a time when the prior player releases a football.

15. The method of claim 12, wherein the at least one athletic performance parameter of each prior player, according to at least one frame of the video record, comprises a distance between a receiver and a closest defender when the receiver catches a football.

16. A method for selecting a particular candidate for a position of quarterback in American-style football, selected from a plurality of candidates, the method comprising:
a) using an Artificial Intelligence (AI) model trained to predict a future athletic performance of a particular candidate of the plurality, according to input data about the particular candidate;
b) recording a video record of the particular candidate playing a football game in the quarterback position;
c) providing, as input to the AI model, the video record or selected frames of the video record;
d) determining, as output from the AI model, a prediction of a success or failure of a particular play action of the particular candidate, the particular play action depicted in particular frames of the video record;
e) comparing the predicted success or failure to a subsequent outcome, the subsequent outcome comprising a success or a failure of the particular play action as indicated in subsequent frames of the video record; and
f) adjusting one or more variables of the AI model to improve the prediction.

17. The method of claim 16, further comprising:
a) evaluating, by a human, an accuracy of the prediction of a success or failure of the particular play action of the particular candidate; and
b) adjusting the one or more variables of the AI model, according to the evaluating, to improve an accuracy of the prediction.

18. The method of claim 16, further comprising:
a) determining, as further output from the AI model, a prediction of an athletic performance of the particular candidate in subsequent professional football games.

19. The method of claim 18, further comprising:
a) providing, as further input to the AI model, video records, or frames thereof, of further candidates of the plurality playing football games; and
b) determining, as further output from the AI model, a comparison of the predicted athletic performance of each of the further candidate of the plurality.

20. The method of claim 18, further comprising:
a) determining, as further output from the AI model, an indication of which candidate, of the plurality, is predicted to perform best in the subsequent professional football games.
